(19) United States
(12) Patent Application Publication
(10) Pub. No.: US 2020/0075025 A1
(43) Pub. Date: Mar. 5, 2020

(54) INFORMATION PROCESSING APPARATUS AND FACILITATION SUPPORT METHOD

(71) Applicant: FUJITSU LIMITED, Kawasaki-shi (JP)

(72) Inventors: Kiyoshi SUWABE, Ota (JP); Koji DEMIZU, Atsugi (JP); Hidekatsu Sasaki, Kawasaki (JP); Yoshihito Okuwaki, Kawasaki (JP)

(73) Assignee: FUJITSU LIMITED, Kawasaki-shi (JP)

(21) Appl. No.: 16/520,451

(22) Filed: Jul. 24, 2019

(30) Foreign Application Priority Data
Aug. 31, 2018 (JP) 2018-162658

(51) Int. Cl. G10L 17/00; G10L 15/07; G10L 25/63; G06K 9/00; G06T 7/73

(52) U.S. Cl. CPC G10L 17/005; G10L 15/07; G06T 7/73; G06K 9/00355; G10L 25/63

(57) ABSTRACT

An information processing apparatus includes a processor that stores speaker information and voice information in association with each of objects described on a board in a discussion, the speaker information being information that identifies a speaker in each of time periods of before, during, and after a description of each of the objects, the voice information being information that identifies a voice of the discussion in each of the time periods related to each of the objects; identifies a speaker in each of the time periods related to a designated object based on the speaker information; outputs information that indicates the identified speaker in each of the time periods related to the designated object in association with each of the time periods; identifies a voice in a designated time period related to the designated object based on the voice information; and outputs data of the identified voice.

### CROSS-REFERENCE TO RELATED APPLICATION

This application is based upon and claims the benefit of priority of the prior Japanese Patent Application No. 2018-162658, filed on Aug. 31, 2018, the entire contents of which are incorporated herein by reference.

### FIELD

The embodiments discussed herein are related to an information processing apparatus and a facilitation support method.

### BACKGROUND

As related art, for example, there has been known a technology of supporting sharing of information in a discussion such as a meeting, a technology of supporting recording of information obtained in a discussion, or a technology of supporting use of recorded information that has been obtained in a discussion. For example, there has been known a technology of using a paper medium as an input area and an image projection area to an image capturing device. Further, there has been known a technology of combining input information and a hand description with each other.

Further, there has been known a technology of recording an information element that describes information, in association with an image or voice acquired while the information element is selected. Further, there has been known a technology of recording a material used in a presentation in association with, for example, voice that explains the material, to reproduce the material in synchronization with video and voice.

Related techniques are disclosed in, for example, Japanese Laid-open Patent Publication No. 2006-202016, Japanese Laid-open Patent Publication No. 2007-257058, Japanese Laid-open Patent Publication No. 2009-194718, and Japanese Laid-open Patent Publication No. 2002-109099.

However, the related art described above has a problem in that it is difficult to identify a speech of a participant of a discussion on an object such as a sentence or an explanatory drawing described on a board such as a whiteboard in the discussion.

For example, in the related art described above, a user may not identify a timing when a specific participant speaks on a specific object described on a board, in a discussion subjected to a voice recording. Accordingly, the user has a difficulty in performing a work of head search for hearing a speech by a desired participant on a desired object from recording data. Thus, it takes time to hear the speech of the desired participant on the desired object.

### SUMMARY

According to an aspect of the embodiments, an information processing apparatus includes a memory; and a processor coupled to the memory and the processor configured to: store, in the memory, speaker information and voice information in association with each of objects described on a board in a discussion, the speaker information being information that identifies a speaker in each of time periods of before, during, and after a description of each of the objects, the voice information being information that identifies a voice from recorded voices of the discussion in each of the time periods related to each of the objects; receive a designation of an object among the objects described on the board; identify a speaker in each of the time periods related to the designated object based on the speaker information stored in the memory; output information that indicates the identified speaker in each of the time periods related to the designated object in association with each of the time periods related to the designated object; receive a designation of a time period from the time periods related to the designated object; identify a voice in the designated time period related to the designated object based on the voice information stored in the memory; and output data of the identified voice.

The object and advantages of the invention will be realized and attained by means of the elements and combinations particularly pointed out in the claims. It is to be understood that both the foregoing general description and the following detailed description are exemplary and explanatory and are not restrictive of the invention, as claimed.

### BRIEF DESCRIPTION OF DRAWINGS

FIG. 1 is a view illustrating an example of a facilitation support by a facilitation support apparatus according to an embodiment;

FIG. 2 is a view illustrating an example of a facilitation support system according to an embodiment;

FIG. 3 is a view illustrating an example of a hardware configuration of the facilitation support apparatus according to the embodiment;

FIG. 4 is a view illustrating an example of the facilitation support apparatus according to the embodiment;

FIG. 5A is a flowchart (part 1) illustrating an example of an information storing process performed by the facilitation support apparatus according to the embodiment;

FIG. 58 is a flowchart (part 2) illustrating an example of the information storing process performed by the facilitation support apparatus according to the embodiment;

FIG. 6 is a view illustrating an example of a meeting state determining process according to an embodiment;

FIG. 7 is a view (part 1) illustrating an example of a description state determining process performed by the facilitation support apparatus according to the embodiment;

FIG. 8 is a view (part 2) illustrating an example of the description state determining process performed by the facilitation support apparatus according to the embodiment;

FIG. 9 is a view (part 3) illustrating an example of the description state determining process performed by the facilitation support apparatus according to the embodiment;

FIG. 10 is a view (part 1) illustrating a first stage in an example of a target meeting of the facilitation support apparatus according to the embodiment;

FIG. 11 is a view (part 2) illustrating the first stage in the example of the target meeting of the facilitation support apparatus according to the embodiment;

FIG. 12 is a view illustrating an example of timings of processes performed by the facilitation support apparatus in the first stage illustrated in FIGS. 10 and 11;

FIG. 13 is a view illustrating an example of information stored in an object information storage by the facilitation support apparatus in the first stage illustrated in FIGS. 10 and 11;

FIG. 14 is a view (part 1) illustrating a second stage in the example of the target meeting of the facilitation support apparatus according to the embodiment;

FIG. 15 is a view (part 2) illustrating the second stage in the example of the target meeting of the facilitation support apparatus according to the embodiment;

FIG. 16 is a view illustrating an example of timings of processes performed by the facilitation support apparatus in the second stage illustrated in FIGS. 14 and 15;

FIG. 17 is a view illustrating an example of information stored in an object information storage by the facilitation support apparatus in the second stage illustrated in FIGS. 14 and 15;

FIG. 18 is a view (part 1) illustrating a third stage in the example of the target meeting of the facilitation support apparatus according to the embodiment;

FIG. 19 is a view (part 2) illustrating the third stage in the example of the target meeting of the facilitation support apparatus according to the embodiment;

FIG. 20 is a view illustrating an example of timings of processes performed by the facilitation support apparatus in the third stage illustrated in FIGS. 18 and 19;

FIG. 21 is a view illustrating an example of information stored in an object information storage by the facilitation support apparatus in the third stage illustrated in FIGS. 18 and 19;

FIG. 22 is a view (part 1) illustrating a fourth stage in the example of the target meeting of the facilitation support apparatus according to the embodiment;

FIG. 23 a view (part 2) illustrating the fourth stage in the example of the target meeting of the facilitation support apparatus according to the embodiment;

FIG. 24 is a view illustrating an example of timings of processes performed by the facilitation support apparatus in the fourth stage illustrated in FIGS. 22 and 23;

FIG. 25 is a view illustrating an example of information stored in an object information storage by the facilitation support apparatus in the fourth stage illustrated in FIGS. 22 and 23;

FIG. 26 is a view (part 1) illustrating a fifth stage in the example of the target meeting of the facilitation support apparatus according to the embodiment;

FIG. 27 is a view (part 2) illustrating the fifth stage in the example of the target meeting of the facilitation support apparatus according to the embodiment;

FIG. 28 is a view illustrating an example of timings of processes performed by the facilitation support apparatus in the fifth stage illustrated in FIGS. 26 and 27;

FIG. 29 is a view illustrating an example of information stored in an object information storage by the facilitation support apparatus in the fifth stage illustrated in FIGS. 26 and 27;

FIG. 30 is a flowchart illustrating an example of an information outputting process performed by the facilitation support apparatus according to the embodiment;

FIG. 31 is a view illustrating an example of an object reproduction screen displayed by the facilitation support apparatus according to the embodiment;

FIG. 32 is a view illustrating an example of a display of a sub-window by the facilitation support apparatus according to the embodiment;

FIG. 33 is a view (part 1) illustrating another example of the display of the sub-window by the facilitation support apparatus according to the embodiment; and

FIG. 34 is a view (part 2) illustrating yet another example of the display of the sub-window by the facilitation support apparatus according to the embodiment.

### DESCRIPTION OF EMBODIMENTS

Hereinafter, embodiments will be described in detail with reference to the accompanying drawings.

### EMBODIMENTS

### Facilitation Support by a Facilitation Support Apparatus According to an Embodiment

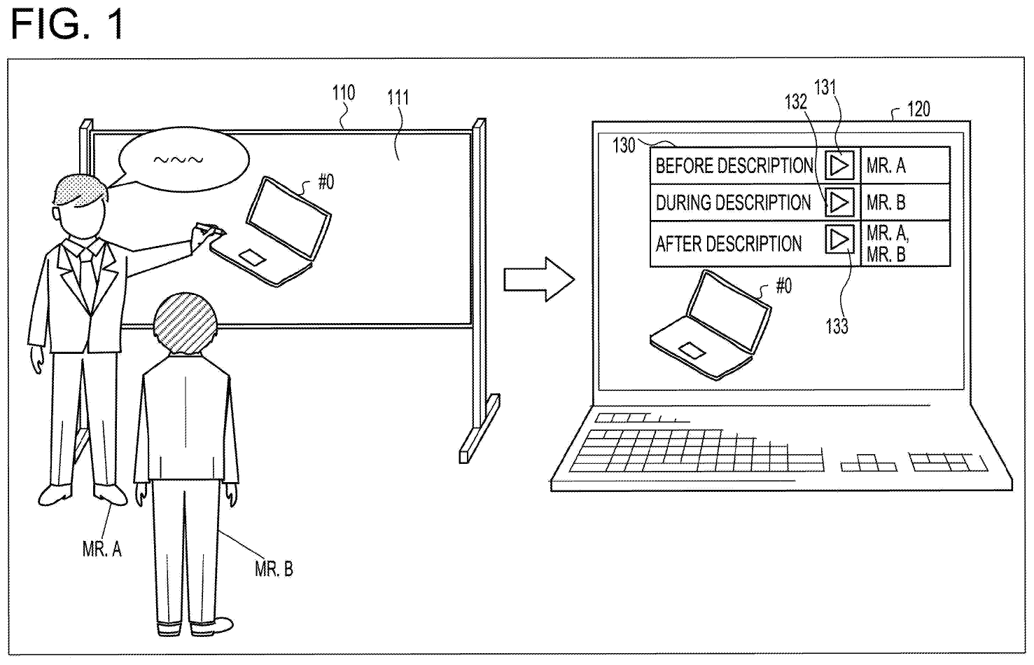

FIG. 1 is a view illustrating an example of a facilitation support by a facilitation support apparatus according to an embodiment. A facilitation support apparatus 120 illustrated in FIG. 1 supports a facilitation for a discussion conducted using a board such as a whiteboard 110. Here, the facilitation relates to, for example, a use of information indicating contents of a discussion which has been completed.

The discussion is an event in which multiple participants give speeches. For example, the discussion includes various events such as a conference, a discussion, a debate, a meeting, a hearing, and a design review. The discussion may be conducted for various purposes such as making an idea, checking a status, and reviewing a method. In addition, the discussion may include an electronic conference or the like in which multiple participants have a conversation through a network. Here, descriptions will be made on an example where multiple participants gather in a specific place such as a meeting room and conduct a meeting using the whiteboard 110 installed in the place.

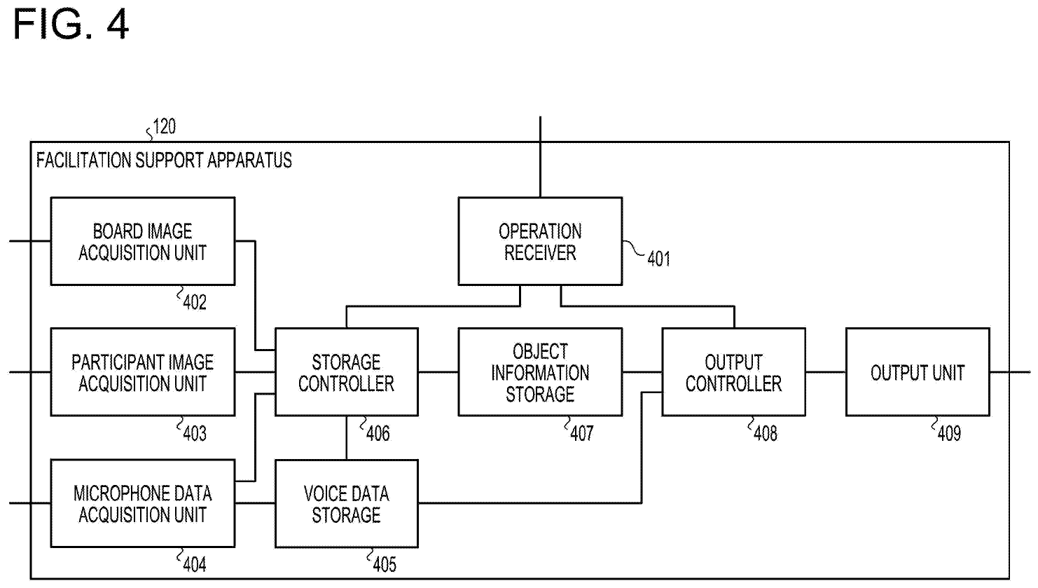

For example, as illustrated in FIG. 1, it is assumed that participants include Messrs. A and B, and a meeting is conducted using the whiteboard 110. The whiteboard 110 has a description area 111 where a description may be performed with a marker or the like using ink. Voices in the meeting are recorded, and voice data obtained by the recording is stored in a storage accessible by the facilitation support apparatus 120 (e.g., a voice data storage 405 illustrated in FIG. 4).

It is assumed that Mr. A describes an object #0 in the description area 111 of the whiteboard 110 in the meeting. The description refers to expressing information by a writing. For example, the description indicates writing characters (including symbols or the like) or drawing figures (including pictures or the like). The object is a series of pieces of information described in the description area 111 of the whiteboard 110. The series of pieces of information is, for example, characters or a drawing described in the description area 111 for a time period from the start of the description operation in the description area 111 to the finish of the description operation.

In the example illustrated in FIG. 1, it is assumed that Mr. A raises his hand holding a marker to the height of the description area 111 to start drawing a notebook personal computer (PC), and lowers the hand holding the marker when the drawing is finished. In this case, the facilitation support device 120 recognizes the drawing of the notebook PC added to the description area 111 for the time period after Mr. A raises his hand until lowering the hand, as one object (the object #0). However, the method of recognizing an object is not limited to the method described above, and various methods may be used as well.

It is assumed that in the meeting described above, Mr. A starts describing the object #0 while making a speech, and continues to speak during the description of the object #0 as illustrated in FIG. 1, and Messrs. A and B speak after Mr. A finishes the description of the object #0.

In this case, a first storage stores information that may identify a speaker among the participants of the meeting in each of the time period of before the start of the description of the object #0, the time period of during the description, and the time period of after the finish of the description, in association with the object #0. The first storage is included in a storage device accessible by the facilitation support apparatus 120.

For example, the first storage is included in a storage device provided in the facilitation support apparatus 120 (e.g., an object information storage 407 illustrated in FIG. 4). Alternatively, the first storage may be included in an external storage device accessible by the facilitation support apparatus 120. For example, the storage of the information described above in the first storage may be performed under the control of the facilitation support apparatus 120 or under the control of an apparatus different from the facilitation support apparatus 120. Hereinafter, descriptions will be made on a case where the facilitation support apparatus 120 controls the storage of the information described above in the first storage.

In addition, a second storage stores information that may identify each voice among voices recorded in the meeting (voices of the entire meeting) in the time period of before the start of the description of the object #0, the time period of during the description, and the time period of after the finish of the description, in association with the object #0. The second storage is included in a storage device accessible by the facilitation support apparatus 120. In addition, the second storage may be included in a storage device including the first storage or a storage device different from the storage device including the first storage.

For example, the second storage is included in the storage device provided in the facilitation support apparatus 120 (e.g., the object information storage 407 illustrated in FIG. 4). Alternatively, the second storage may be included in an external storage device accessible by the facilitation support apparatus 120. For example, the storage of the information described above in the second storage may be performed under the control of the facilitation support apparatus 120 or the control of an apparatus different from the facilitation support apparatus 120. Hereinafter, descriptions will be made on a case where the facilitation support apparatus 120 controls the storage of the information described above in the second storage.

The time period of before the start of the description of the object #0 is a time period before the description of the object #0 is started. For example, when the object #0 is described for the first time in the meeting, the time period of before the start of the description of the object #0 is the time period from the beginning of the meeting until the start of the description of the object #0. In addition, when the object #0 is described after the first object or later in the meeting, the time period of before the start of the description of the object #0 is the time period from the finish of the description of the object described before the object #0 until the start of the description of the object #0. Hereinafter, the terms “before the start of the description” will be referred to as “before the description.”

The time period of during the description of the object #0 is the time period from the start of the description of the object #0 until the finish of the description of the object #0.

The time period of after the finish of the description of the object #0 is the time period after the description of the object #0 is finished. For example, when the object #0 is an object described last in the meeting, the time period of after the finish of the description of the object #0 is the time period from the finish of the description of the object #0 until the end of the meeting. When the object #0 is an object described before the last object or earlier in the meeting, the time period of after the finish of the description of the object #0 is the time period from the finish of the description of the object #0 until the start of the description of the object described after the object #0. Hereinafter, the terms “after the finish of the description” will be referred to as “after the description.”

In the example illustrated in FIG. 1, the first storage described above stores information that may identify Mr. A as a speaker in the time period of before the description of the object #0 (e.g., identification information of Mr. A) in association with the object #0. Further, the first storage described above stores information that may identify Mr. A as a speaker in the time period of during the description of the object #0 in association with the object #0. Further, the first storage described above stores information that may identify Messrs. A and B as speakers in the time period of after the description of the object #0 (e.g., identification information of each of Messrs. A and B) in association with object #0.

The facilitation support apparatus 120 receives a designation (selection) of an object among objects described in the description area 111, from the user. When the designation of an object is received, the facilitation support apparatus 120 refers to the first storage described above, and identifies a speaker in each of the time periods of before, during, and after the description of the designated object.

For example, it is assumed that the user performs an operation to designate the object #0 on the facilitation support apparatus 120. In this case, the facilitation support apparatus 120 identifies Mr. A as a speaker in the time period of before the description of the object #0, Mr. A as a speaker in the time period of during the description of the object #0, and Messrs. A and B as speakers in the time period of after the description of the object #0.

Then, the facilitation support apparatus 120 outputs the information that may identify the identified speaker in each of the time periods of before, during, and after the description of the object #0, in association with the time periods of before, during, and after the description of the object #0. In the example illustrated in FIG. 1, the facilitation support apparatus 120 displays association information 130 by a display. In the association information 130, the time period before the description and Mr. A are associated with each other, the time period during the description and Mr. B are associated with each other, and the time period after the description and Messrs. A and B are associated with each other, with respect to the object #0.

As a result, the user may identify a speaker in each of the time periods of before, during, and after the description of the object #0, with respect to the object #0. Alternatively, the user may identify a time period when a specific participant speaks, among the time periods of before, during, and after the description of the object #0, with respect to the object #0.

The facilitation support apparatus 120 receives a designation of a time period among the time periods of before, during, and after the description of the designated object #0, from the user. For example, in the association information 130, reproduction buttons 131 to 133 are provided in association with the time periods of before, during, and after the description, respectively.

For example, when the user performs an operation to designate the reproduction button 131, the facilitation support apparatus 120 determines that a designation of the time period before the description has been received. In addition, when the user performs an operation to designate the reproduction button 132, the facilitation support apparatus 120 determines that a designation of the time period during the description has been received. In addition, when the user performs an operation to designate the reproduction button 133, the facilitation support apparatus 120 determines that a designation of the time period after the description has been received. When a designation of a time period is received, the facilitation support apparatus 120 refers to the second storage described above, and identifies voice in the designated time period among the voices recorded in the meeting.

Then, the facilitation support apparatus 120 outputs data of the identified voice. The data of the identified voice is voice data for reproducing the identified voice. For example, the facilitation support apparatus 120 outputs the data of the identified voice to a speaker so as to reproduce the identified voice.

For example, when the voices of the entire time periods of the meeting are stored as one voice data, the facilitation support apparatus 120 identifies a reproduction position that corresponds to the designated time period, in the voices of the entire time periods of the meeting indicated by the voice data. Then, the facilitation support apparatus 120 reproduces the voice of the identified reproduction position, among the voices of the entire time periods of the meeting based on the stored voice data.

In addition, the voices of the meeting may be stored as voice data divided at timings of a start and a finish of a description of an object. In this case, the facilitation support apparatus 120 identifies voice data that corresponds to the designated time period, in the divided voice data. Then, the facilitation support apparatus 120 reproduces the identified voice data from the head.

For example, it is assumed that the user desires to refer to Mr. B's speech on the object #0 described in the description area 111. In this case, the user performs an operation to designate the object #0 and refers to the association information 130 displayed by the operation, to identify that Mr. B is speaking after the description of the object #0. Accordingly, the user performs an operation to designate the reproduction button 133 associated with the time period of after the description of the object #0.

In this regard, the facilitation support apparatus 120 receives the operation to designate the reproduction button 133, and thus, determines that the time period after the description of the object #0 has been received. Then, the facilitation support apparatus 120 refers to the second storage described above, and identifies the voice in the time period of after the description of the object #0. Then, the facilitation support apparatus 120 reads the voice data stored in the storage described above, and reproduces the identified voice.

As a result, the user may hear the voice in the partial time period including Mr. B's speech on the object #0 among the entire time periods of the meeting. Thus, the user may efficiently identify Mr. B's speech on the object #0. For example, the user may identify Mr. B's speech on the object #0 in a shorter time than that for hearing the voices of the entire time periods of the meeting from the beginning to refer to Mr. B's speech on the object #0.

In addition, the time periods of before, during, and after the description of the object #0 correspond to the respective stages of the conversation on the object #0. That is, it may be understood that the stages of the conversation on the object #0 are progressed at the timings of the start and the finish of the description of the object #0. Accordingly, it is highly likely that speakers are different from each other in the respective time periods of before, during, and after the description.

For example, it is assumed that Mr. B is a participant in the position to make a conclusion in the conversation on the object #0. In this case, it is highly likely that Mr. B is to give a speech after the description of the object #0, rather than before and during the description of the object #0. Accordingly, by identifying a speaker in each of the time periods of before, during, and after the description, it is possible to provide the user with a time period when a specific participant is speaking, separately from a time period when the participant is not speaking. Thus, the user may efficiently identify a speech of a specific participant (e.g., Mr. B) on a specific object which is described in the description area 111 (e.g., the object #0).

In this way, according to the facilitation support apparatus 120 illustrated in FIG. 1, the contents of the meeting on the object described in the description area 111 of the whiteboard 110 are easily identified so that the facilitation may be supported.

For example, according to the facilitation support apparatus 120, the user may easily perform the work of head search. The head search is to find the head of a desired portion of recorded voice. For example, the user may refer to a speaker in each of the time periods of before, during, and after the description which are presented on a designated object, and designate a time period including a desired speaker so as to hear the speech of the speaker.

For example, the user may not perform the work of reproducing recorded data from the beginning and waiting until a speech of a desired participant on a desired object is reproduced. Alternatively, the user may not perform the work of repeating the reproduction of voice at a position predicated to include a speech of a desired participant on a desired object in recorded data, until the speech of the desired participant on the desired object is found. Accordingly, the user may easily and quickly hear a speech of a desired participant on a desired object.

### Facilitation Support System According to an Embodiment

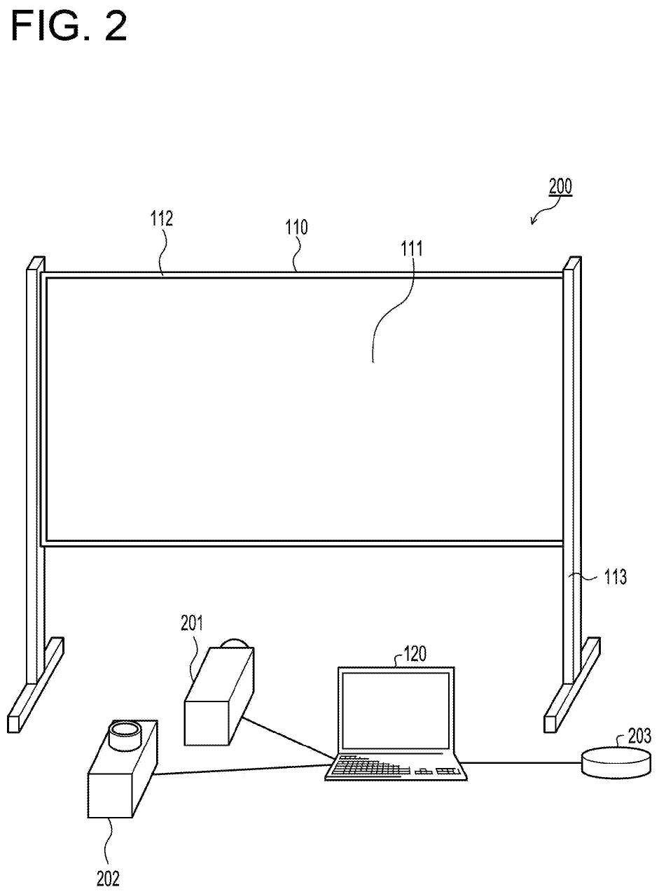

FIG. 2 is a view illustrating an example of a facilitation support system according to an embodiment. In FIG. 2, portions similar to those illustrated in FIG. 1 will be denoted by the same reference numerals as used in FIG. 1, and descriptions thereof will be omitted. As illustrated in FIG. 2, a facilitation support system 200 includes a whiteboard 110, a facilitation support apparatus 120, a board image capturing camera 201, a participant image capturing camera 202, and a microphone 203.

The whiteboard 110 includes the above-described rectangular description area 111 where an object may be described using a marker or the like, a frame 112 that surrounds the description area 111, and legs 113 that hold the description area 111 and the frame 112 in a state of standing with a predetermined height.

The board image capturing camera 201 captures an image of an object described in the description area 111 of the whiteboard 110 or a person between the board image capturing camera 201 and the whiteboard 110. For example, the board image capturing camera 201 is provided at a position that faces the description area 111 to capture an image of the entire description area 111 of the whiteboard 110. In addition, the board image capturing camera 201 is connected to the facilitation support apparatus 120 to transmit captured image data which is obtained by the image capturing to the facilitation support apparatus 120.

The participant image capturing camera 202 captures an image of a participant in the meeting using the whiteboard 110. For example, the participant image capturing camera 202 is provided at a position that is surrounded by participants in front of the whiteboard 110. In addition, the participant image capturing camera 202 is connected to the facilitation support apparatus 120 to transmit captured image data which is obtained by the image capturing to the facilitation support apparatus 120.

The microphone 203 records voices in the meeting using the whiteboard 110. For example, the microphone 203 is provided at a position where a speech of each participant in the meeting may be recorded. In addition, the microphone 203 is connected to the facilitation support apparatus 120, to transmit voice data obtained by the recording to the facilitation support apparatus 120.

The facilitation support apparatus 120 stores information or voice data on an object described in the description area 111. In addition, the facilitation support apparatus 120 reproduces information or voice data on a stored object. In the example illustrated in FIG. 2, the facilitation support apparatus 120 is a notebook PC. However, the facilitation support apparatus 120 is not limited to the notebook PC, and may be a desktop or tablet PC.

A storage medium where the facilitation support apparatus 120 stores information or voice data on an object (each storage described above) is, for example, a storage medium mounted in the facilitation support apparatus 120. Alternatively, a storage medium where the facilitation support apparatus 120 stores information or voice data on an object may be an external storage medium accessible by the facilitation support apparatus 120. In addition, a computer different from the facilitation support apparatus 120 may reproduce the above-described information or voice data on an object by accessing the storage medium described above.

### Hardware Configuration of the Facilitation Support Apparatus According to the Embodiment

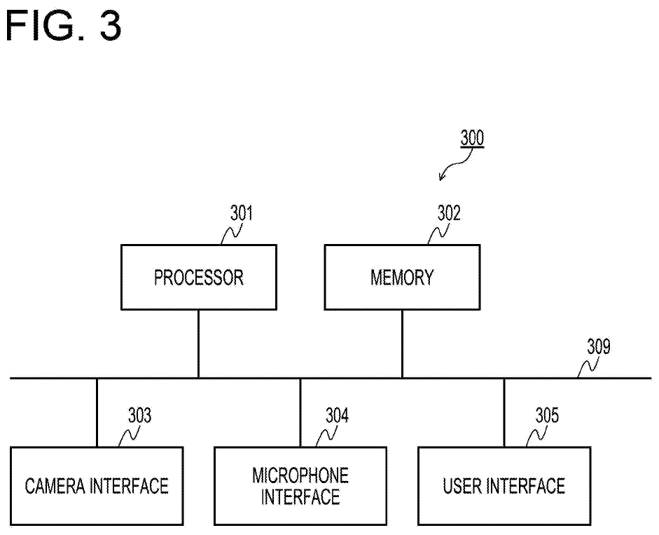

FIG. 3 is a view illustrating an example of a hardware configuration of the facilitation support apparatus according to the embodiment. The facilitation support apparatus 120 illustrated in FIG. 1 may be implemented by, for example, a computer 300 illustrated in FIG. 3. The computer 300 includes a processor 301, a memory 302, a camera interface 303, a microphone interface 304, and a user interface 305. The processor 301, the memory 302, the camera interface 303, the microphone interface 304, and the user interface 305 are connected to each other by, for example, a bus 309.

The processor 301 is a circuit that performs a signal processing and is, for example, a central processing unit (CPU) that performs an overall control of the computer 300. The memory 302 includes, for example, a main memory and an auxiliary memory. The main memory is, for example, a random access memory (RAM). The main memory is used as a work area of the processor 301.

The auxiliary memory is, for example, a nonvolatile memory such as a magnetic disk, an optical disk or a flash memory. The auxiliary memory stores various programs for operating the computer 300. The programs stored in the auxiliary memory are loaded into the main memory and executed by the processor 301.

In addition, the auxiliary memory may include a portable memory that is separable from the computer 300. The portable memory is, for example, a memory card such as a USB flash drive or an SD memory card, or an external hard disk drive. The USB stands for universal serial bus. For example, the SD stands for secure digital.

The camera interface 303 performs a wired or wireless communication with the board image capturing camera 201 and the participant image capturing camera 202 illustrated in FIG. 2. The camera interface 303 is controlled by the processor 301. The microphone interface 304 performs a wired or wireless communication with the microphone 203 illustrated in FIG. 2. The microphone interface 304 is controlled by the processor 301.

The user interface 305 includes, for example, an input device that receives an operation input from the user or an output device that outputs information to the user. The input device may be implemented by, for example, a pointing device (e.g., a mouse), keys (e.g., a keyboard), or a remote controller. The output device may be implemented by, for example, a display or a speaker. In addition, the input device and the output device may be implemented by a touch panel or the like. The user interface 305 is controlled by the processor 301.

### Facilitation Support Apparatus According to the Embodiment

FIG. 4 is a view illustrating an example of the facilitation support apparatus according to the embodiment. For example, as illustrated in FIG. 4, the facilitation support apparatus 120 according to the embodiment includes an operation receiver 401, an acquisition unit of a board image acquisition unit 402, a participant image acquisition unit 403, and a microphone data acquisition unit 404. Further, the facilitation support apparatus 120 includes a voice data storage 405, a storage controller 406, an object information storage 407, an output controller 408, and an output unit 409. A processing result in each unit of the facilitation support apparatus 120 is stored in, for example, a storage device such as the memory 302 illustrated in FIG. 3.

The operation receiver 401 receives an operation from the user of the facilitation support apparatus 120. Then, when an operation related to a storage of information is received, the operation receiver 401 outputs instruction information corresponding to the received operation, to the storage controller 406. In addition, when an operation related to a reproduction of information is received, the operation receiver 401 outputs instruction information corresponding to the received operation, to the output controller 408.

The board image acquisition unit 402 acquires captured image data which is transmitted from the board image capturing camera 201 illustrated in FIG. 2, and outputs the acquired data to the storage controller 406. The captured image data which is acquired by the board image acquisition unit 402 may be data of images captured at a periodic timing or video data based on data of images captured continuously in a sequential manner.

The participant image acquisition unit 403 acquires captured image data which is transmitted from the participant image capturing camera 202 illustrated in FIG. 2, and outputs the acquired data to the storage controller 406. The captured image data which is acquired by the participant image acquisition unit 403 may be data of images captured at a periodic timing or video data based on data of images captured continuously in a sequential manner.

The microphone data acquisition unit 404 acquires voice data transmitted from the microphone 203 illustrated in FIG. 2, and outputs the acquired voice data to the storage controller 406 and the voice data storage 405. The voice data storage 405 stores the voice data output from the microphone data acquisition unit 404.

The storage controller 406 controls the storage of information on an object by the object information storage 407. The control by the output controller 408 is performed based on, for example, instruction information output from the operation receiver 401. The instruction information is, for example, information that is received by the operation receiver 401 when the meeting is started and instructs to start the storage of information of the meeting. For example, the storage controller 406 performs a voice data storing process, a speaker detecting process, a participant state determining process, and a description state determining process. Hereinafter, each of the processes will be described.

The voice data storing process sequentially stores voice data output from the microphone 203 in the memory 302. At this time, for example, the storage controller 406 sequentially stores voice data output from the microphone 203 during the meeting as one voice data in the voice data storage 405. Alternatively, the storage controller 406 may divide voice data output from the microphone 203 during the meeting, at the timings of the start and the finish of a description which are determined by the description state determining process to be described later, and store each divided voice data in the voice data storage 405.

The speaker detecting process determines the presence/absence of a speech at the current time in the meeting, and when it is determined that a speech has been made, the speaker detecting process identifies a speaker who has made the speech from participants of the meeting. The speaker detecting process is performed based on, for example, a voice print or voice direction detected from voice indicated by the voice data output from the microphone data acquisition unit 404. In addition, the speaker detecting process may be performed based on, for example, a participant state detected from captured image data which is output from the participant image acquisition unit 403.

As an example, the speaker detecting process may be performed using voice data output from the microphone data acquisition unit 404 and an API such as a speaker recognition API for performing a speaker identification from voice data. The API stands for application programming interface. In addition, the speaker detecting process may include a process of determining a state of an identified speaker.

The speaker state determining process may be performed by using, for example, captured image data which is output from the participant image capturing camera 202 and an API such as a face API or a Haar-Cascade. The face API determines an emotion of a person from a face image of the person (calculates a reliability of each emotion). The emotions that may be determined by the face API include, for example, “anger,” “contempt,” “disgust,” “fear,” “joy,” “neutral,” “sadness,” “surprise” and others. The Haar-Cascade is an API that detects a smiling face. In addition, the speaker state determining process may be performed using, for example, information of brain waves of a speaker measured by a brain wave measuring apparatus, or a mental state of a speaker determined from voice data output from the microphone data acquisition unit 404.

The participant state determining process determines a state of a participant of the meeting at the current time. The participant state is, for example, a state of emotions of each participant of the meeting. For example, the participant state is an emotion of each participant of the meeting which is determined using the face API described above or the like. In this case, in the participant state determining process, the storage controller 406 determines an emotion of each participant of the meeting as the participant state, based on captured image data which is output from the participant image acquisition unit 403, and the face API described above.

In addition, the participant state may be a state of each participant whether each participant of the meeting is in the state of smiling face which is determined using the Haar-Cascade described above or the like. In this case, in the participant state determining process, the storage controller 406 determines the state of each participant whether each participant of the meeting is in the state of smiling face, as the participant state, based on captured image data which is output from the participant image acquisition unit 403 and the Haar-Cascade described above.

In addition, the participant state may be a smiling face index that indicates a proportion of participants determined to be in the state of smiling face among participants of the meeting, based on whether each participant of the meeting is in the state of smiling face. In this case, in the participant state determining process, the storage controller 406 determines the smiling face index obtained by dividing the number of participants determined to be in the state of smiling face by the number of participants of the meeting, as the result of the participant state determination, based on the result of the determination of whether each participant of the meeting is in the state of smiling face.

In addition, in the participant state determining process, the storage controller 406 may determine the participant state using, for example, a voice recognition based on voice data output from the microphone data acquisition unit 404 or a measurement result of a brain wave measuring apparatus for measuring brain waves of a participant.

The description state determining process determines a state of description in the description area 111. The state of description in the description area 111 is a state of whether a description is being performed in the description area 111 (a state of description or non-description). The description state determining process is performed based on, for example, captured image data obtained from the board image capturing camera 201. An example of the description state determining process will be described later (see, e.g., FIGS. 7 to 9).

The object information storage 407 stores information on an object described in the description area 111 under the control of the storage controller 406. An example of the information stored in the object information storage 407 will be described later.

The output controller 408 controls the output of information on an object stored in the object information storage 407 and voice data stored in the voice data storage 405 which are output by the output unit 409, based on instruction information output from the operation receiver 401. The control by the output controller 408 is performed according to, for example, instruction information based on an operation received by the operation receiver 401 after the end of the meeting. The instruction information includes, for example, information that instructs to display objects described in the description area 111 during the meeting, information that instructs an object among the objects, and information that instructs voice to be reproduced among voices in the time periods of before, during, and after the description of the object.

The output unit 409 outputs information on an object stored in the object information storage 407 under the control of the output controller 408. Further, the output unit 409 reproduces voice stored in the voice data storage 405 under the control of the output controller 408. An example of the output of information by the output unit 409 will be described later (see, e.g., FIGS. 31 to 34).

The first storage and the second storage described above using FIG. 1 may be implemented by, for example, by the object information storage 407. In addition, a first identifying unit that identifies a participant and a second identifying unit that identifies voice as described above using FIG. 1 may be implemented by, for example, the output controller 408. In addition, a first output unit that outputs information which may identify a participant and a second output unit that outputs voice data as described above using FIG. 1 may be implemented by, for example, the output unit 409.

The operation receiver 401 and the output unit 409 which are illustrated in FIG. 4 may be implemented by, for example, the user interface 305 illustrated in FIG. 3. The board image acquisition unit 402 and the participant image acquisition unit 403 which are illustrated in FIG. 4 may be implemented by, for example, the camera interface 303 illustrated in FIG. 3. The microphone data acquisition unit 404 illustrated in FIG. 4 may be implemented by, for example, the microphone interface 304 illustrated in FIG. 3.

The storage controller 406 and the output controller 408 which are illustrated in FIG. 4 may be implemented by, for example, the processor 301 and the memory 302 which are illustrated in FIG. 3. The voice data storage 405 and the object information storage 407 which are illustrated in FIG. 4 may be implemented by, for example, the auxiliary memory included in the memory 302 illustrated in FIG. 3.

### Information Storing Process by the Facilitation Support Apparatus According to the Embodiment

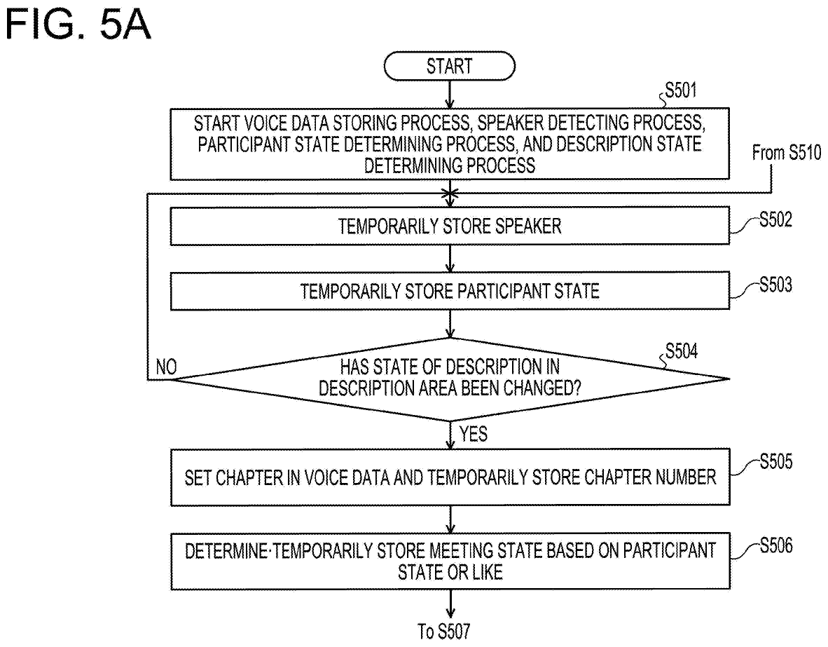

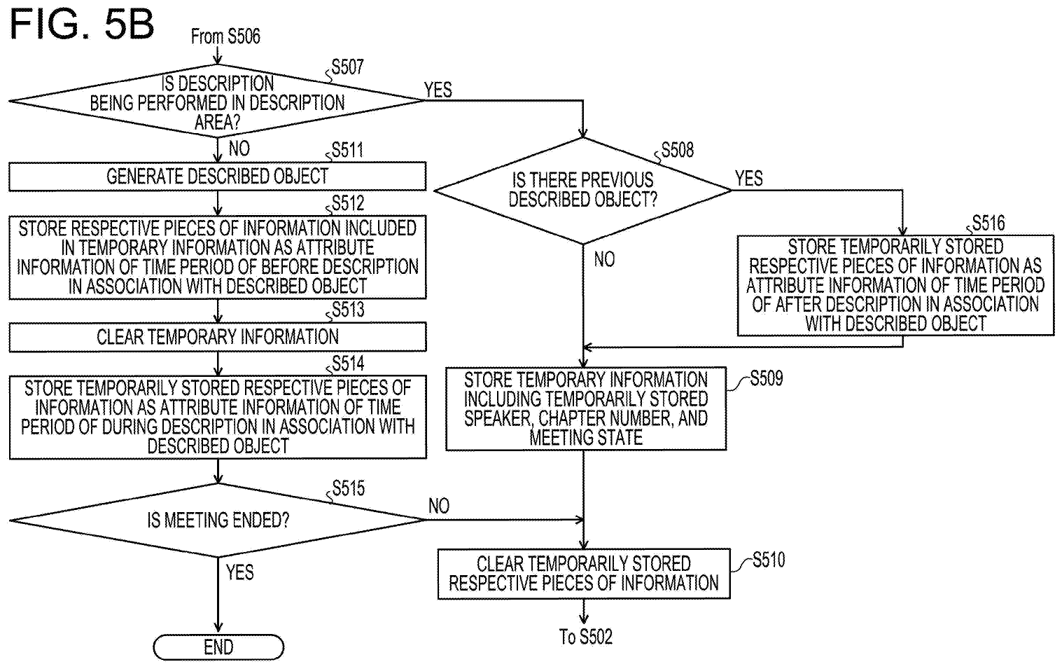

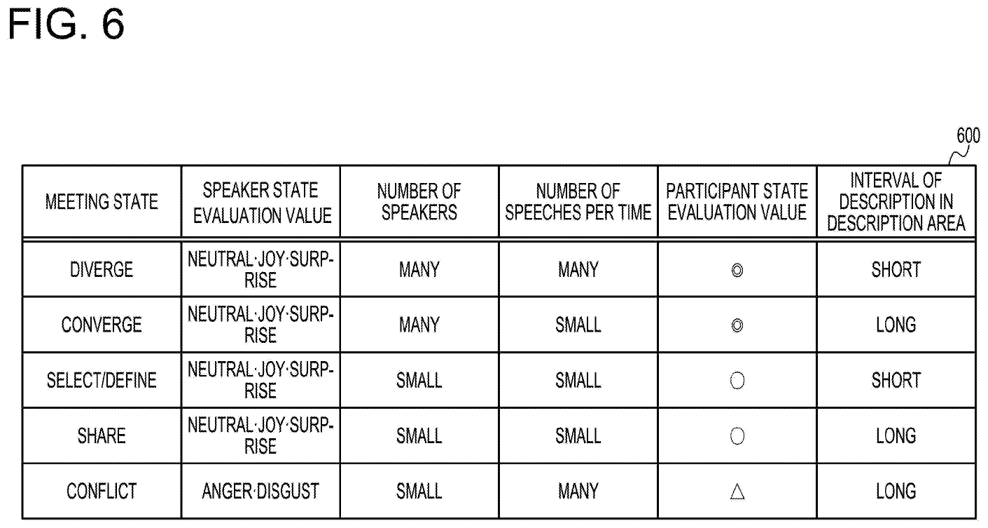

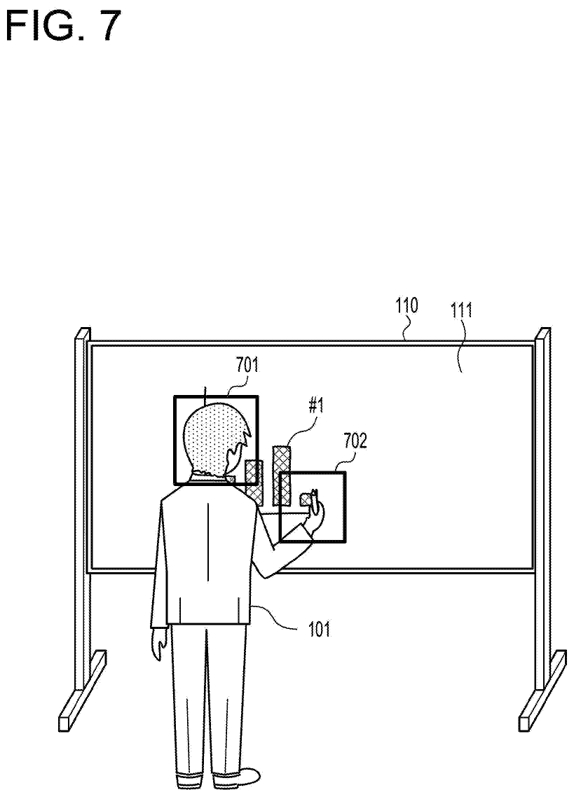

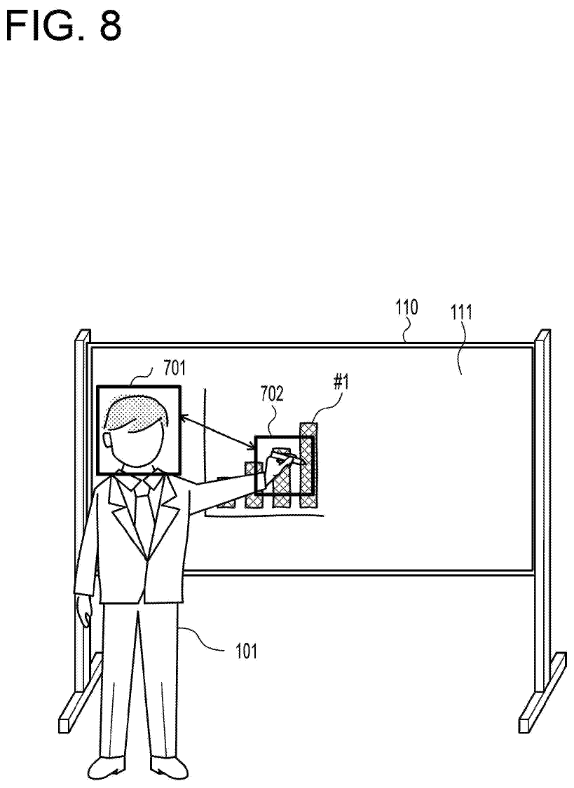

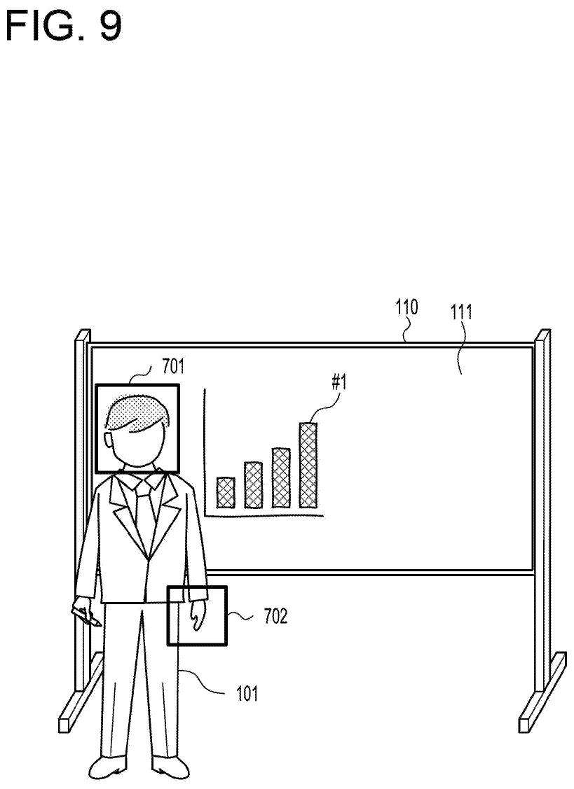

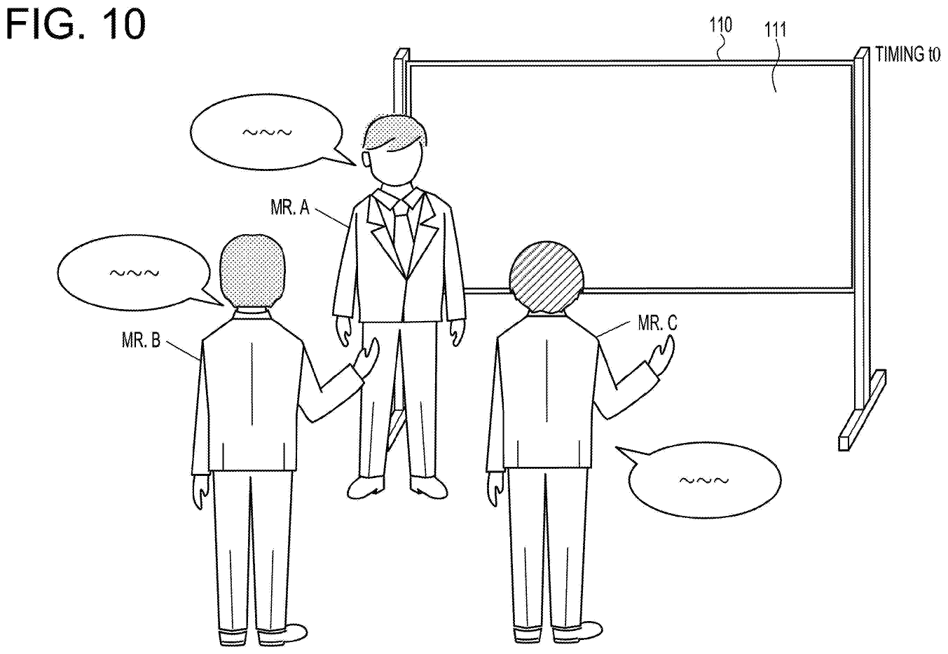

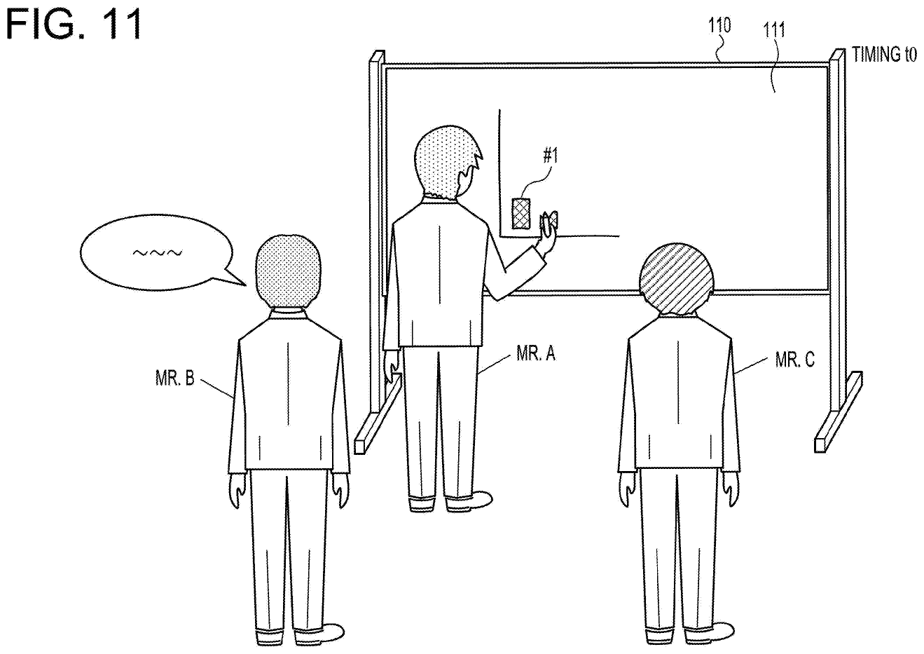

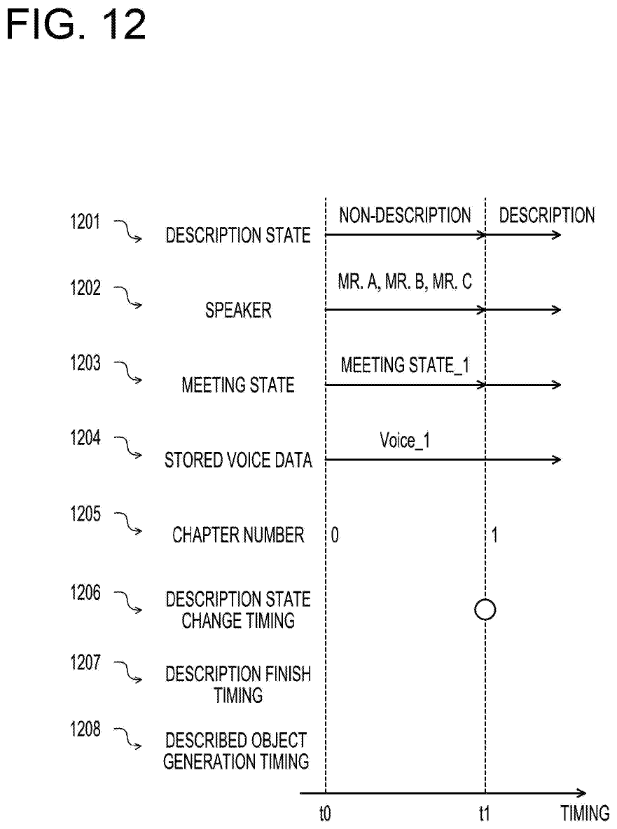

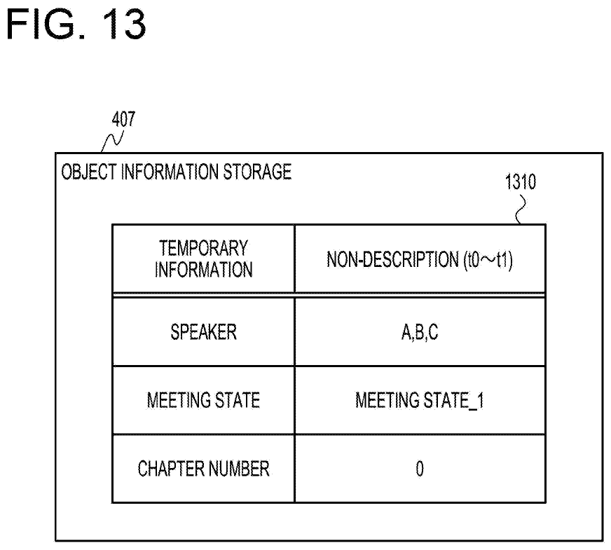

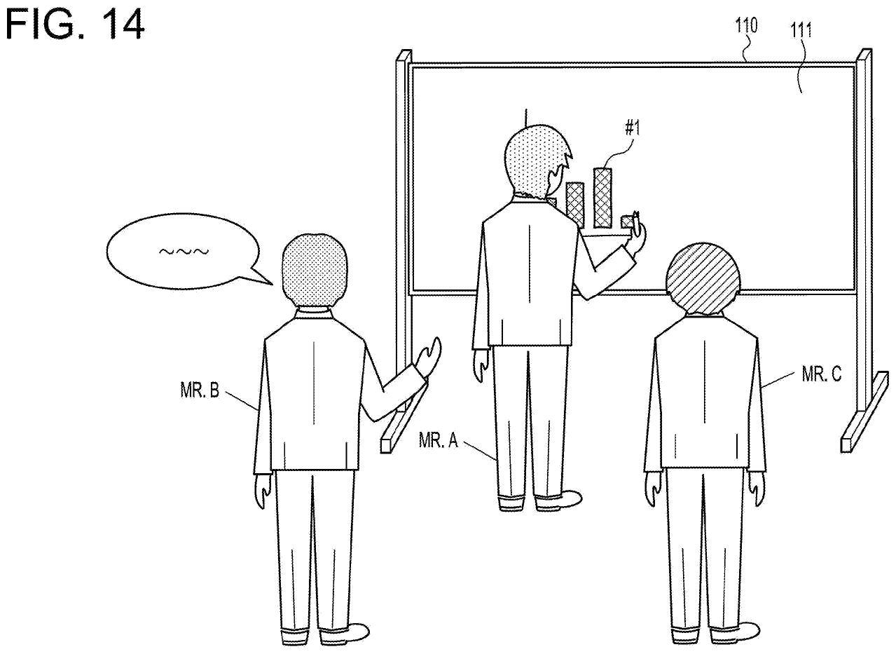

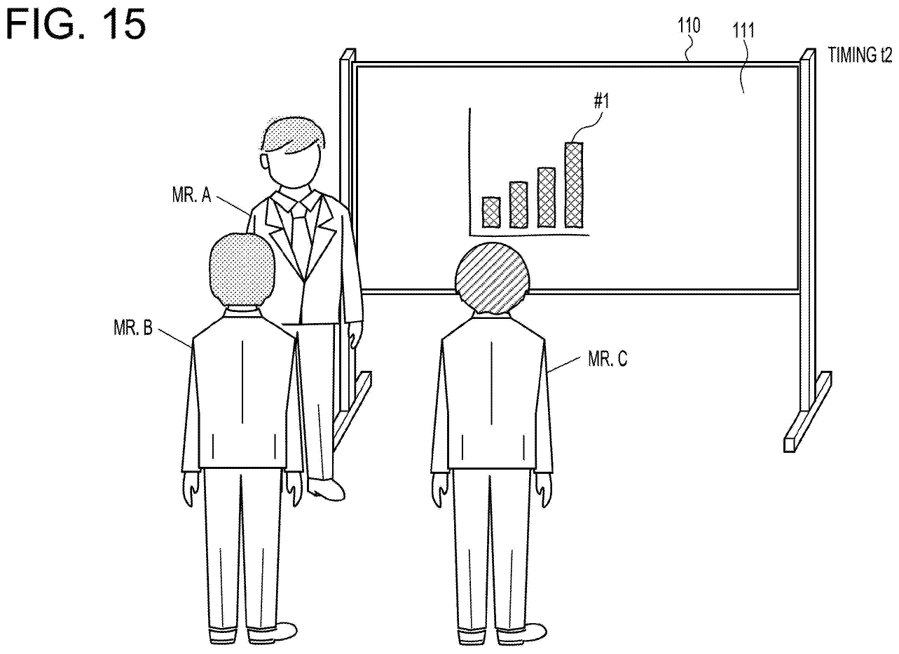

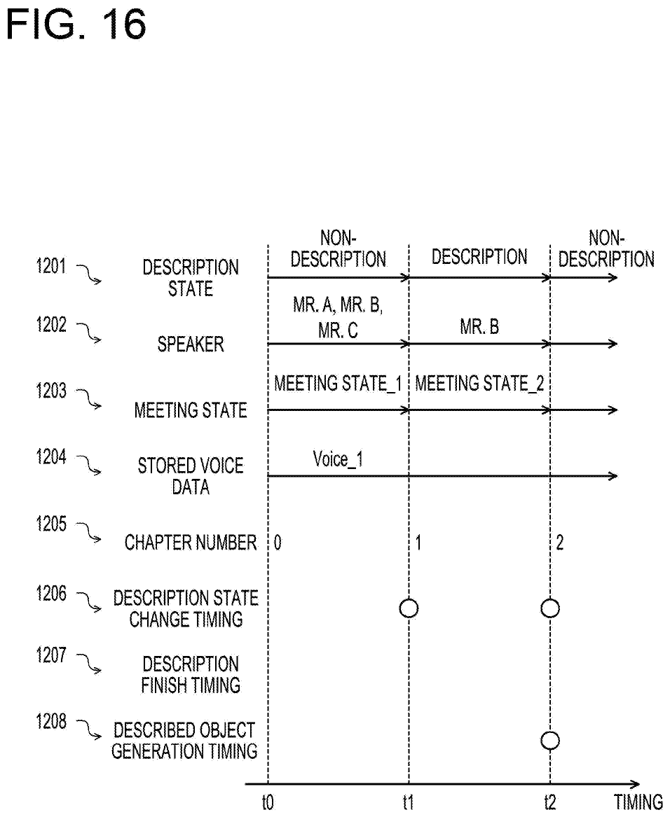

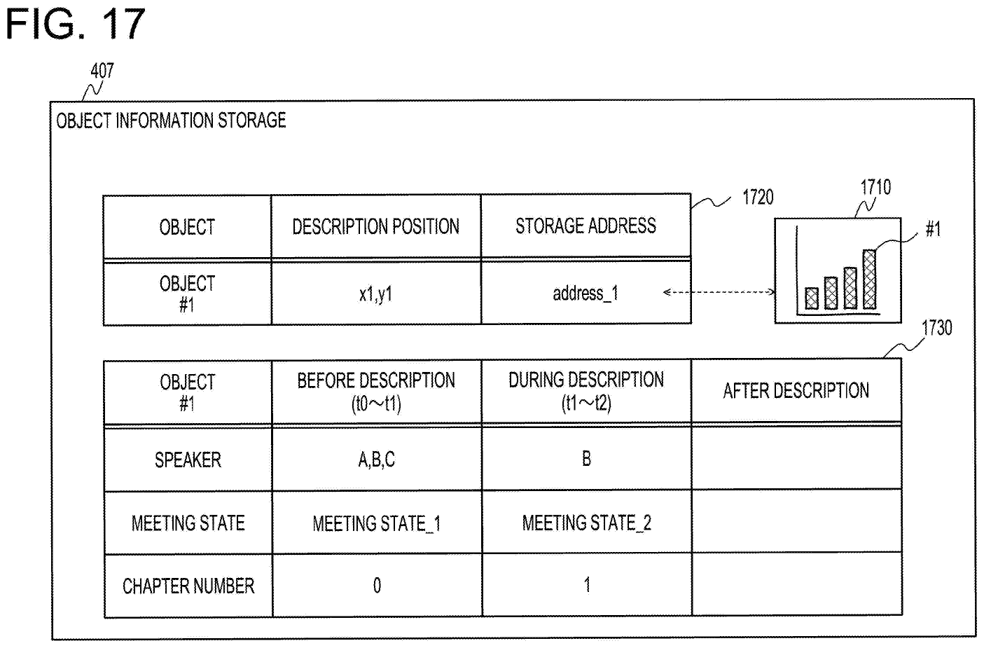

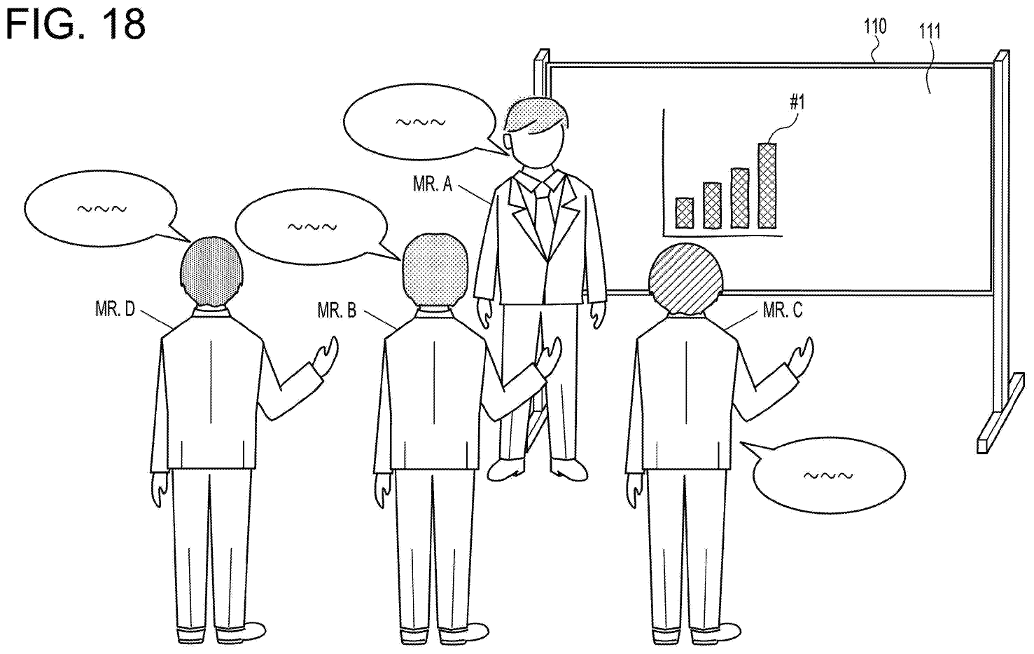

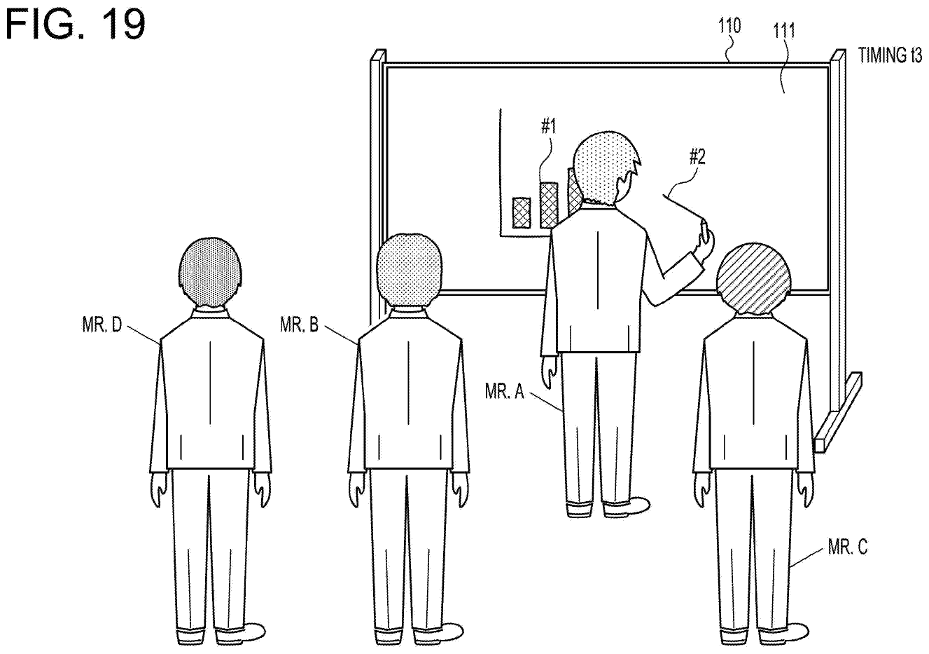

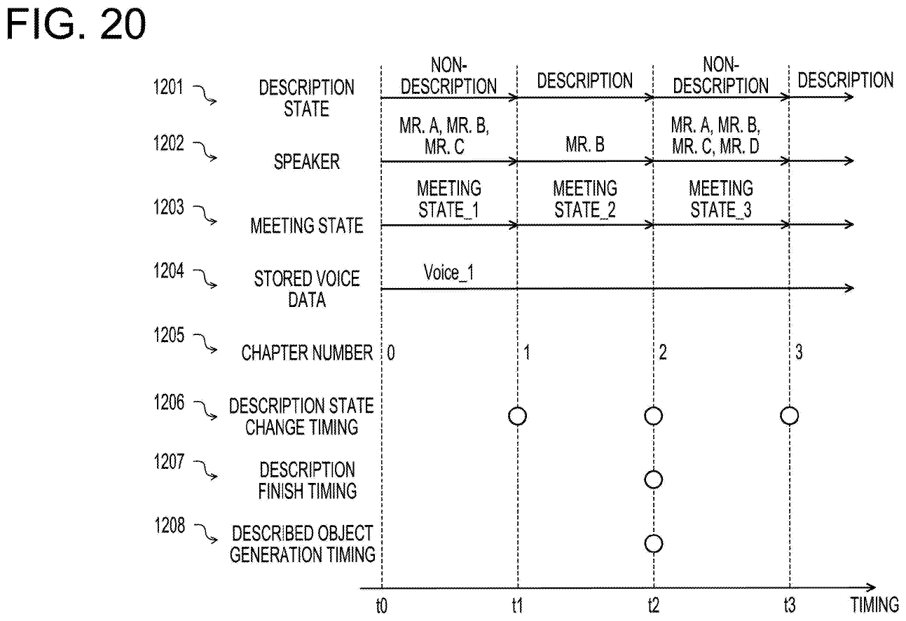

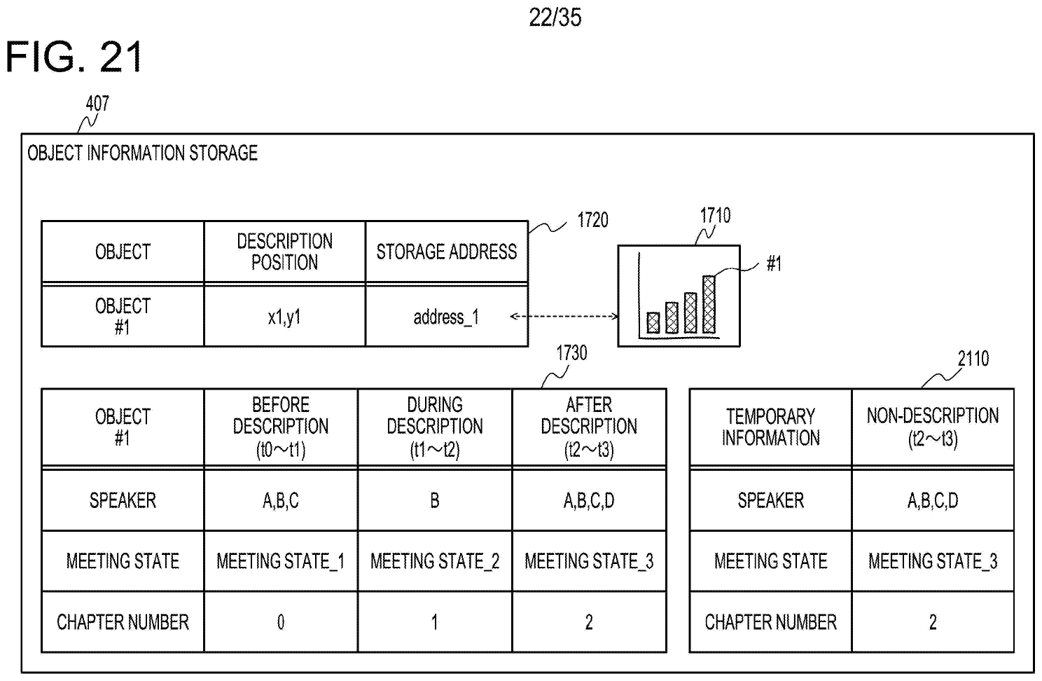

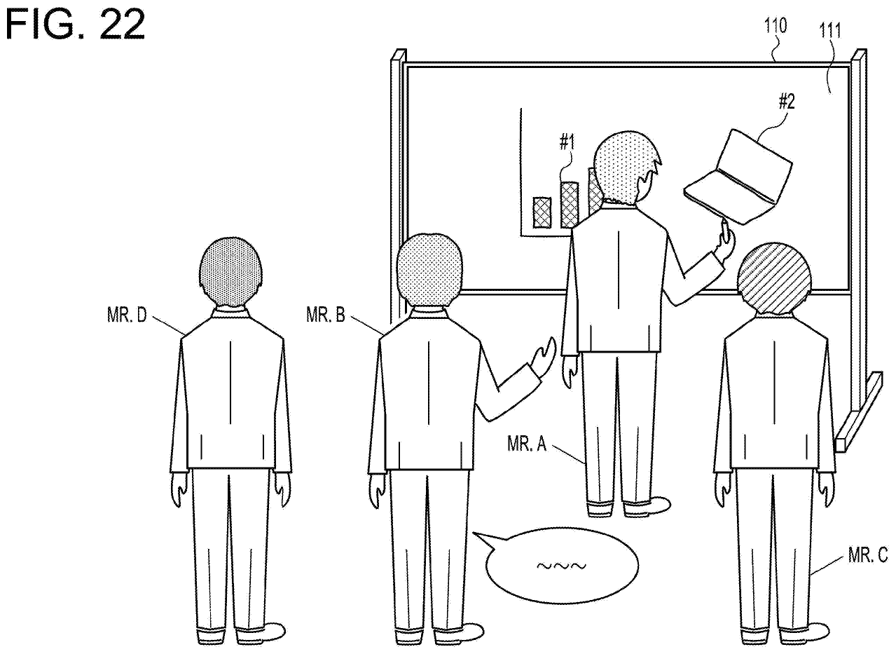

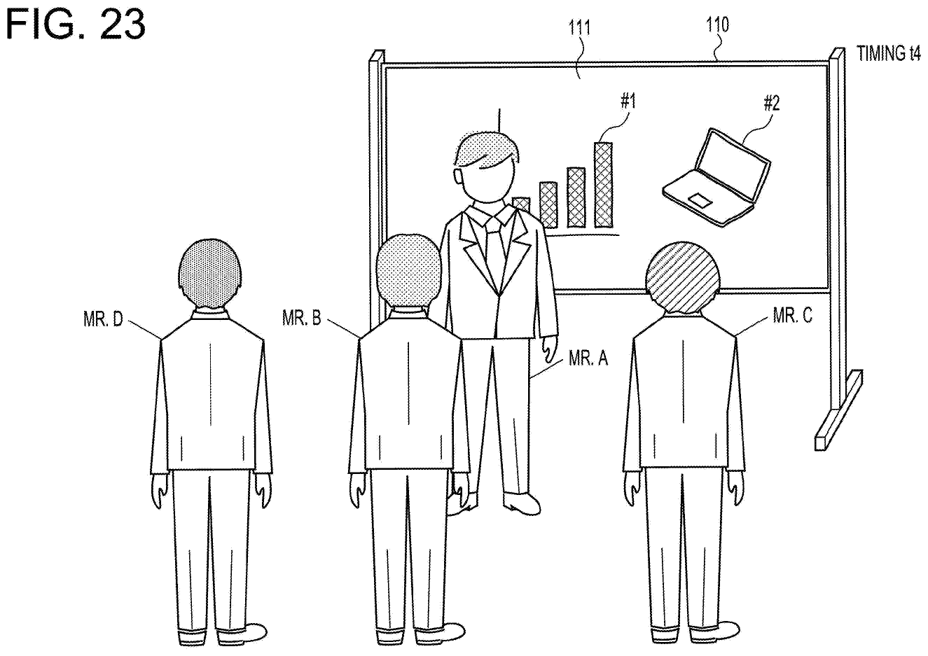

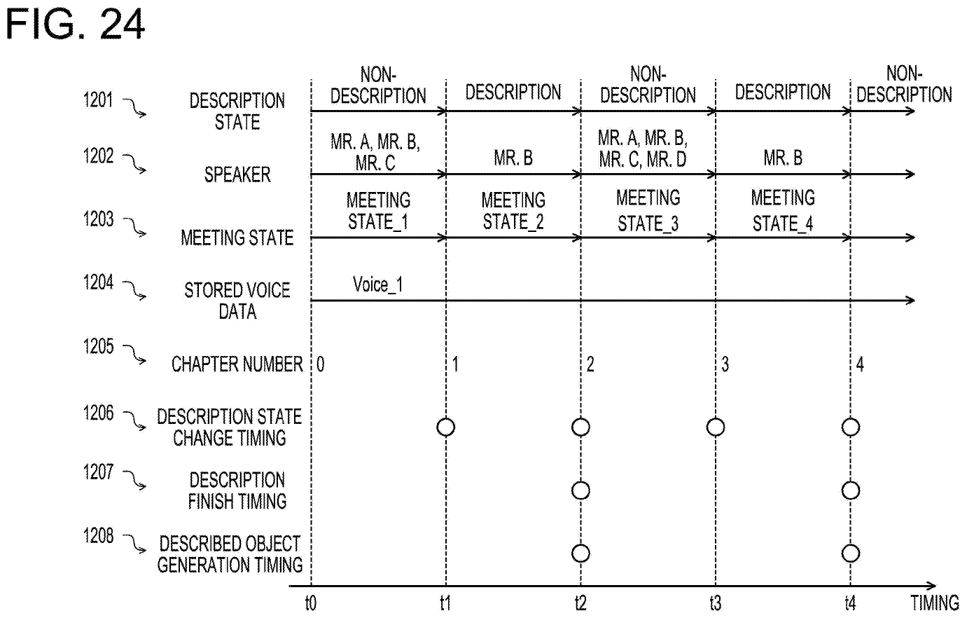

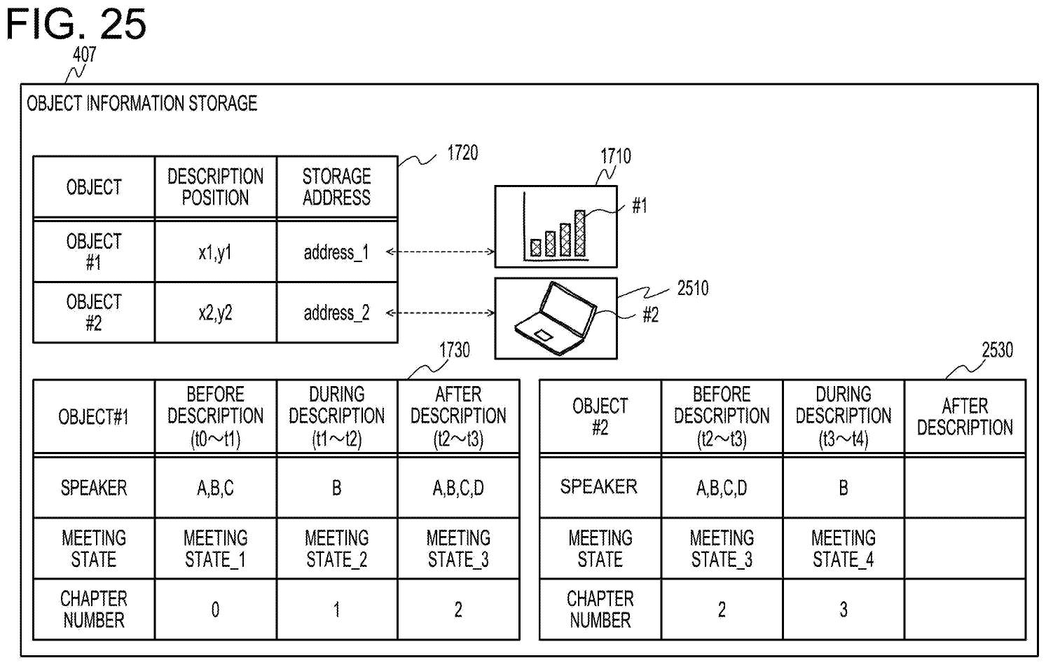

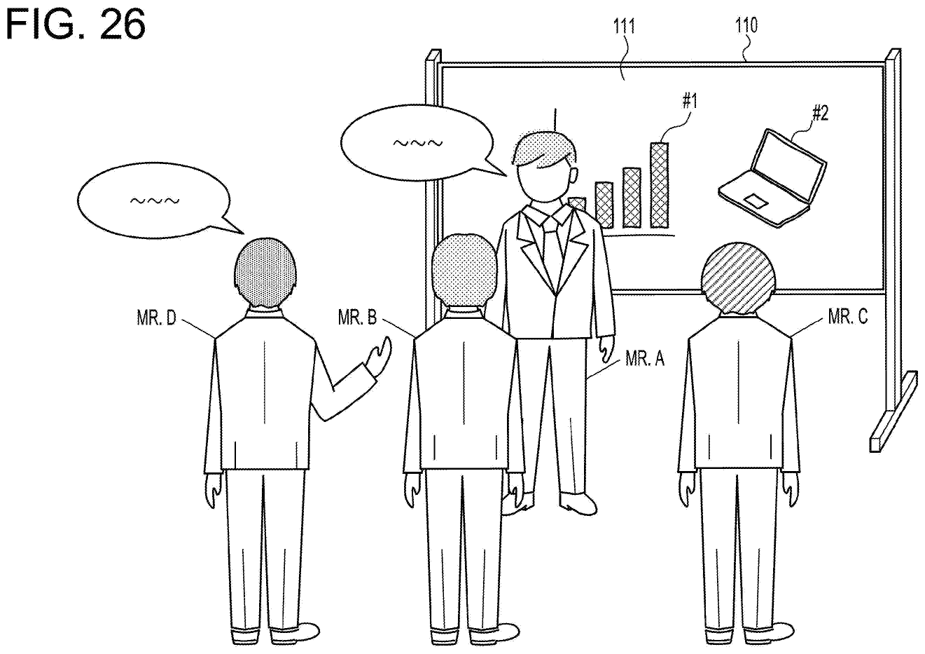

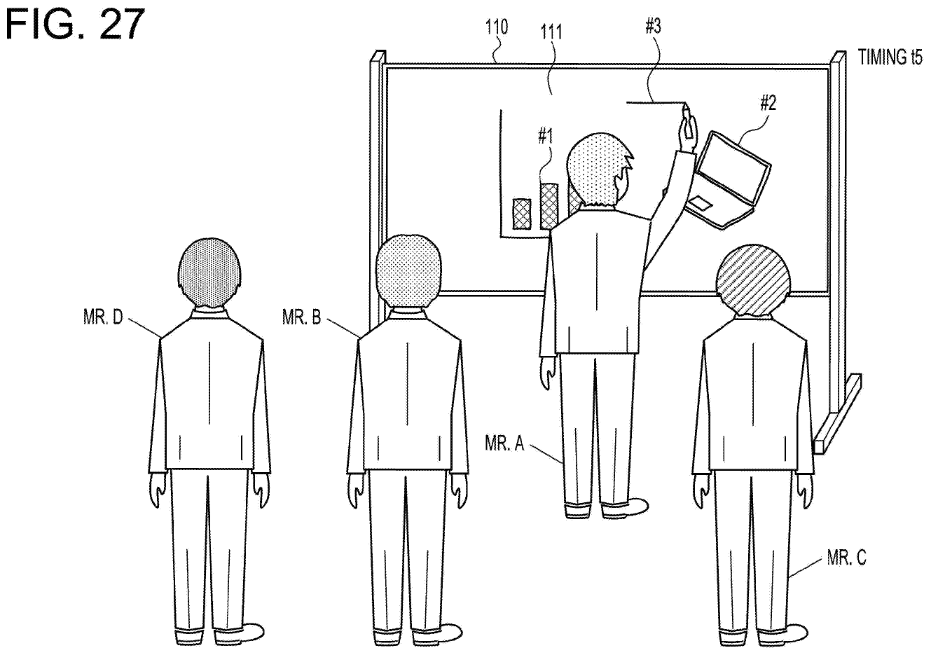

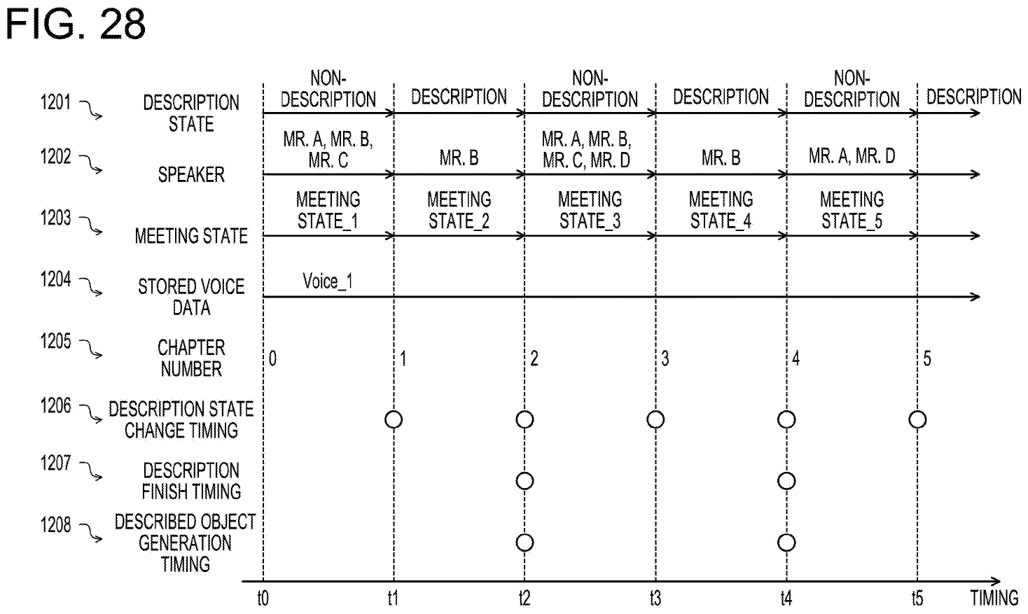

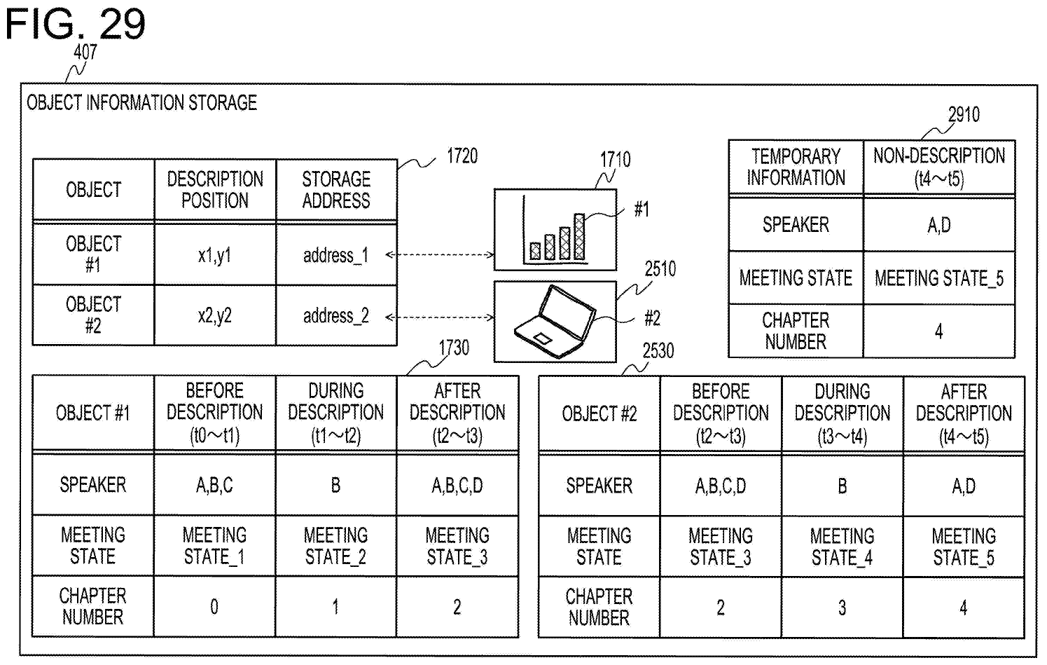

FIGS. 5A and 5B are flowcharts illustrating an example of the information storing process performed by the facilitation support apparatus according to the embodiment. When the meeting using the whiteboard 110 is started, and an operation to instruct the storage of information is received, the facilitation support apparatus 120 according to the embodiment starts the information storing process illustrated in, for example, FIGS. 5A and 5B. The information storing process illustrated in FIGS. 5A and 5B is executed by, for example, the storage controller 406 illustrated in FIG. 4.

First, as illustrated in FIG. 5A, the facilitation support apparatus 120 starts the above-described voice data storing process, speaker detecting process, participant state determining process, and description state determining process (step S501). The processes started in step S501 are repeated until the information storing process illustrated in, for example, FIGS. 5A and 5B is ended.

Subsequently, the facilitation support apparatus 120 temporarily stores a speaker at the current time in the object information storage 407, based on the result of the speaker detecting process started in step S501 (step S502). The temporary storage indicates temporarily storing information, separately from information to be stored in association with a described object which is generated in, for example, step S511 to be described later. In step S502, for example, when there is no speaker at the current time, information indicating that there is no speaker is temporarily stored. When there is one speaker at the current time, identification information of the speaker is temporarily stored. When there are two or more speakers at the current time, identification information of each of the speakers is temporarily stored.

Further, the facilitation support apparatus 120 temporarily stores the above-described participant state at the current time in the object information storage 407, based on the result of the participant state determining process started in step S501 (step S503). The participant state is, for example, the smiling face index that indicates a proportion of participants in the state of smiling face as described above. The steps S502 and S503 may be interchanged in an order.

Subsequently, the facilitation support apparatus 120 determines whether the state of description in the description area 111 has been changed, based on the result of the description state determining process started in step S501 (step S504). The change of the description state includes a change from non-description to description (start of description) and a change from description to non-description (finish of description).

When it is determined in step S504 that the description state has not been changed (step S504: “No”), the facilitation support apparatus 120 returns to step S502. When it is determined that the description state has been changed (step S504: “Yes”), the facilitation support apparatus 120 proceeds to step S505. That is, the facilitation support apparatus 120 sets a chapter at a position corresponding to the current time in the voice data being stored in the voice data storage 405 by the voice data storing process started in step S501. Then, the facilitation support apparatus 120 temporarily stores a chapter number indicating the set chapter in the object information storage 407 (step S505).

Further, the facilitation support apparatus 120 determines a meeting state based on, for example, the participant state temporarily stored in step S503, and temporarily stores the determined meeting state in the object information storage 407 (step S506). The meeting state determining process in step S506 will be described later. The steps S505 and S506 may be interchanged in an order.

Subsequently, as illustrated in FIG. 5B, the facilitation support apparatus 120 determines whether a description is being performed in the description area 111, based on the result of the description state determining process started in step S501 (step S507). When it is determined that a description is being performed (step S507: “Yes”), this result indicates that the change of the description state determined in step S504 corresponds to the start of description. In this case, the facilitation support apparatus 120 determines whether a described object that indicates an object described in the description area 111 before the object being described at the current time exists in the object information storage 407 (step S508).

When it is determined in step S508 that no previous described object exists (step S508: “No”), this result indicates that the object being described at the current time is described for the first time in the description area 111. In this case, the facilitation support apparatus 120 stores temporary information including the speaker, the chapter number, and the meeting state which are temporarily stored in the object information storage 407, in the object information storage 407 (step S509). The temporary information is temporarily stored, separately from information to be stored in association with a described object which is generated by, for example, step S511 to be described later.

Subsequently, the facilitation support apparatus 120 dears the respective pieces of information temporarily stored in the object information storage 407 (step S510), and returns to step S502 illustrated in FIG. 5A. The respective pieces of information cleared in step S510 are, for example, the speaker, the participant state, the chapter number, and the meeting state which are temporarily stored in steps S502, S503, S505, and S506. That is, the temporary information stored in step S509 is not cleared at this time.

When it is determined in step S507 that no description is being performed (step S507: “No”), this result indicates that the change of the description state determined in step S504 corresponds to the finish of description. In this case, the facilitation support apparatus 120 generates a described object that indicates an object of which description has been finished (step S511). The described object is image data indicating an object. The image data may be various image data such as bitmap data including information of each pixel of an image, and vector data representing an image in a mathematical expression or a formula (a collection of analytical geometric figures).

Subsequently, the facilitation support apparatus 120 stores the respective pieces of information included in the stored temporary information, as attribute information in the time period of before the description in association with the described object which has been generated in step S511, in the object information storage 407 (step S512). The temporary information used in step S512 is the information stored in the object information storage 407 in step S509. The respective pieces of information included in the temporary information are information of the speaker, the chapter number, and the meeting state. Subsequently, the facilitation support apparatus 120 clears the temporary information stored in the object information storage 407 in step S509 (step S513).

Further, the facilitation support apparatus 120 stores the respective pieces of information being temporarily stored at the current time, as attribute information in the time period of during the description in association with the described object which has been generated in step S511, in the object information storage 407 (step S514). The temporarily stored respective pieces of information include the speaker, the chapter number, and the meeting state that have been temporarily stored in steps S502, S505, and S506. The steps S512/S513 and S506 may be interchanged in an order.

Subsequently, the facilitation support apparatus 120 determines whether the meeting is ended (step S515). The determination of whether the meeting is ended may be performed by, for example, determining whether the operation receiver 401 receives an operation indicating the end of the meeting or determining whether a voice indicating the end of the meeting is detected. When it is determined that the meeting is not ended (step S515: “No”), the facilitation support apparatus 120 proceeds to step S510.

When it is determined in step S508 that the previous described object exists (step S508: “Yes”), the facilitation support apparatus 120 proceeds to step S516. That is, the facilitation support apparatus 120 stores the respective pieces of information temporarily stored in steps S502, S505, and S506, as attribute information in the time period of after the description in association with the previous described object, in the object information storage 407 (step S516). Then, the facilitation support apparatus 120 proceeds to step S509. The temporarily stored respective pieces of information include the speaker, the chapter number, and the meeting state.

When it is determined in step S515 that the meeting is ended (step S515: “Yes”), the facilitation support apparatus 120 ends the series of steps for the information storing process.

### Meeting State Determining Process According to the Embodiment

FIG. 6 is a view illustrating an example of the meeting state determining process according to the embodiment. The memory 302 of the facilitation support apparatus 12 stores, for example, a meeting state determination table 600 illustrated in FIG. 6. In the meeting state determination table 600, the meeting state is associated with each combination of a speaker state evaluation value, the number of speakers, the number of speeches per time, a participant state evaluation value, and an interval of description in the description area.

For example, in step S506 illustrated in FIG. 5A, the facilitation support apparatus 120 determines the combination of the speaker state evaluation value, the number of speakers, the number of speeches per time, the participant state evaluation value, and the interval of description in the description area, with respect to a previous time period. The previous time period is a time period immediately before a time period of the current time, among the time periods of the meeting discriminated at the timings of the start and the finish of description in the description area 111.

The facilitation support apparatus 120 determines the meeting state based on the determined combination and the meeting state determination table 600, with respect to the previous time period. As a result, the facilitation support apparatus 120 may determine the meeting state of each of the time periods during the meeting which are discriminated at the timings of the start and the finish of description in the description area 111.

The meeting state of the meeting state determination table 600 includes “Diverge,” “Converge,” “Select/Define,” “Share,” and “Conflict.” The “Diverge” is, for example, a state where participants give various speeches. The “Converge” is, for example, a state where the speeches given in the “Diverge” are summarized and discussions converge. The “Select/Define” is, for example, a state where contents to be discussed are selected or an ambiguous matter is defined. The “Share” is, for example, a state where participants share a presumption or conclusion of the meeting. The “Conflict” is, for example, a state where participants disagree with each other and continue a discussion.

In the meeting state determination table 600, the speaker state evaluation value is an evaluation value of the speaker state detected in a target time period, and is determined by the above-described speaker detecting process. In the example illustrated in FIG. 6, the speaker state evaluation value includes two states of, for example, “neutral, joy, or surprise” and “anger or disgust.” For example, when the emotion of anger or disgust is detected once from a speaker in the target time period, the speaker state evaluation value for the target time period is determined to be “anger or disgust.” Otherwise, the speaker state evaluation value for the target time period is determined to be “neutral, joy, or surprise.”

In the meeting state determination table 600, the number of speakers is the number of speakers detected in a target time period. For example, the number of speakers is determined by counting speakers detected by the above-described speaker detecting process (e.g., the speaker recognition API) in the target time period.

As an example, when Mr. A first speaks, Mr. B then speaks, and subsequently, Mr. A speaks in the target time period, the number of speakers in the time period is determined to be two. In the example illustrated in FIG. 6, the number of speakers is indicated as “many” or “small.” For example, when the number of speakers is equal to or more than a predetermined threshold, the number of speakers is determined to be “many,” and when the number of speakers is less than the threshold, the number of speakers is determined to be “small.”

In the meeting state determination table 600, the number of speeches per time is the number of speeches per time detected in a target time period. For example, the number of speeches per time is determined by counting speeches detected by the above-described speaker detecting process (e.g., the speaker recognition API) in the target time period, and dividing the number of counted speeches by the time length of the target time period. For example, the counting of speeches may be performed by counting up the number of speeches each time a speaker switches, by using the speaker recognition API or the like.

As an example, in a case where a time period when Mr. A first speaks, Mr. B then speaks, and Mr. A finally speaks is two minutes in the target time period, the number of speeches per time for the time period is determined to be 3÷2=1.5. In the example illustrated in FIG. 6, the number of speeches per time is indicated as “many” or “small.” For example, when the number of speeches per time is equal to or more than a predetermined threshold, the number of speeches per time is determined to be “many,” and when the number of speeches per time is less than the threshold, the number of speeches per time is determined to be “small.”

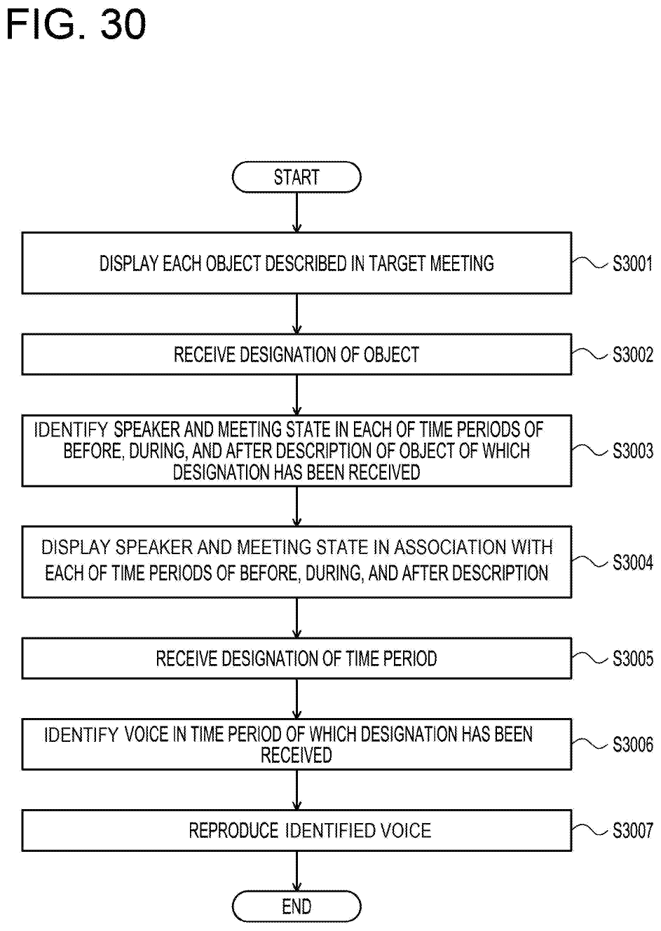

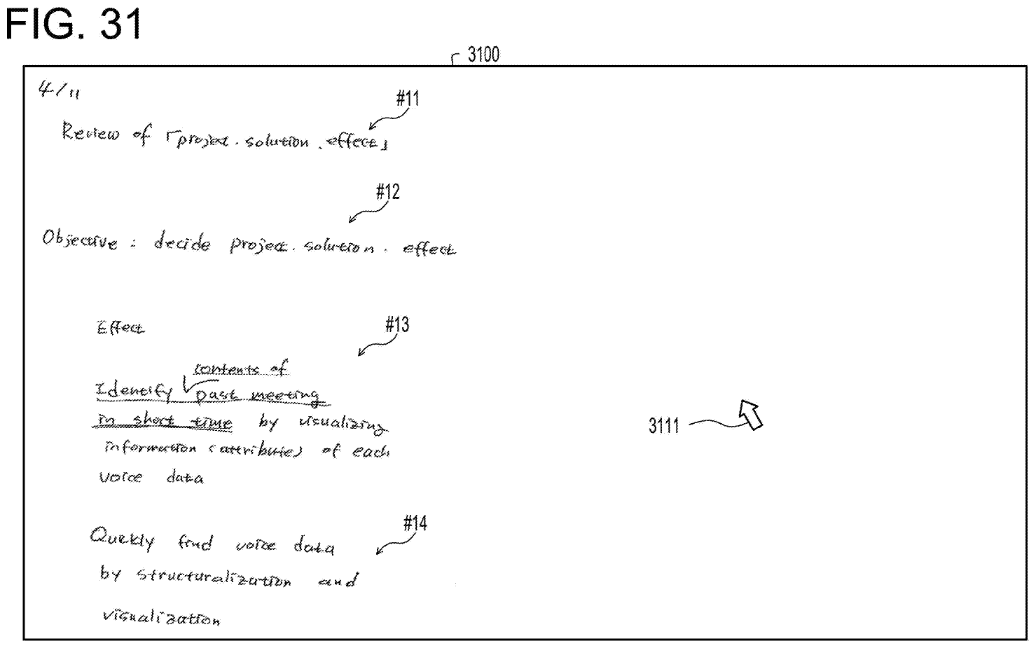

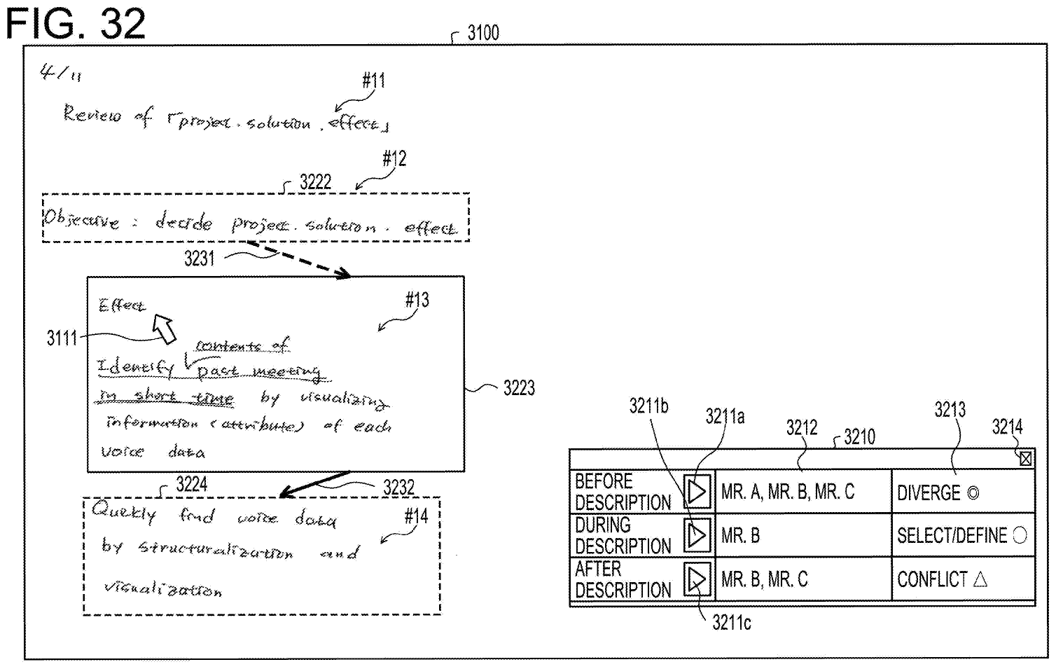

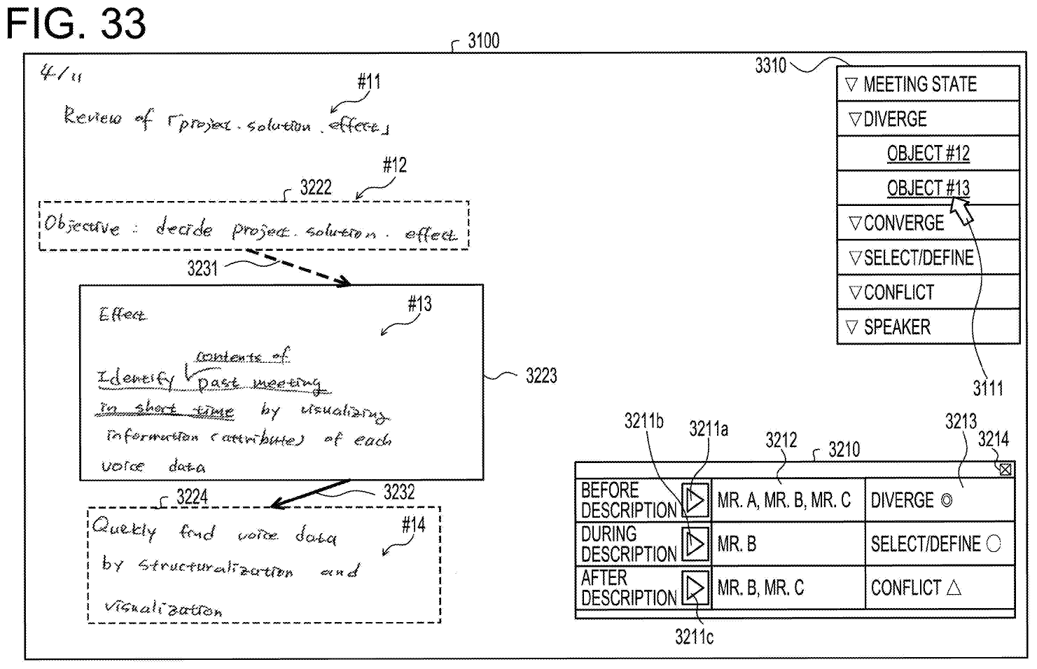

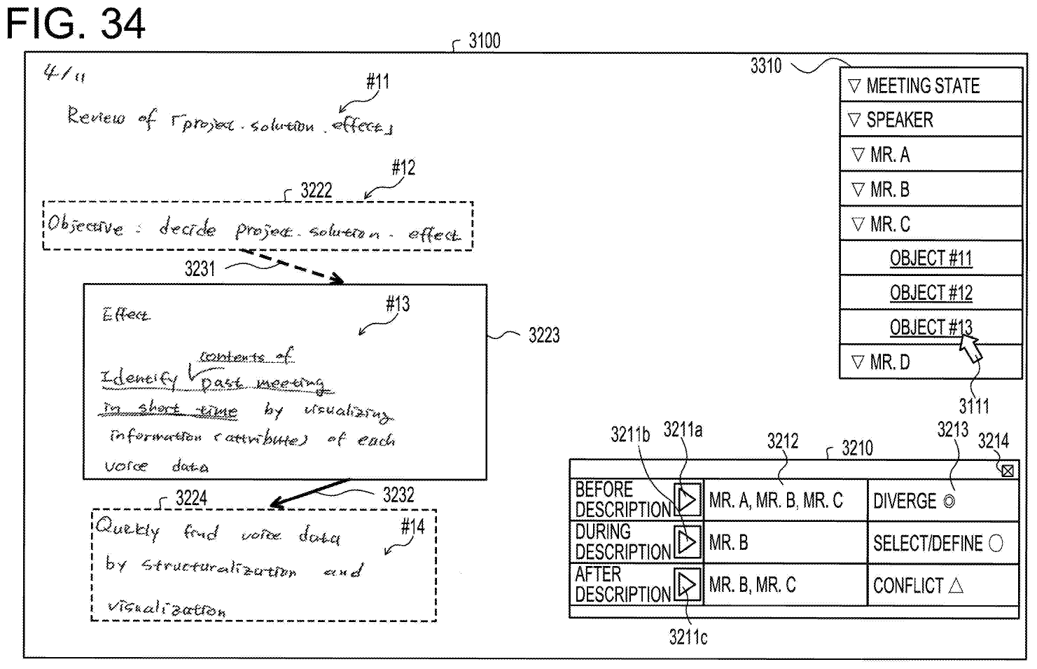

In the meeting state determination table 600, the participant state evaluation value is an evaluation value based on the participant state determined by the participant state determining process in step S503 illustrated in FIGS. 5A and 58, in a target time period. For example, it is assumed that the participant state is the above-described smiling face index that is determined using the above-described Haar-Cascade or the like (a proportion of participants in the state of smiling face).

In this case, the participant state evaluation value may be, for example, a representative value of the smiling face index determined in the target time period. The representative value is, for example, an average value, a median value or a most frequent value. For example, it is assumed that step S503 illustrated in FIGS. 5A and 5B is executed 100 times in the target time period, and an average value of the 100 smiling face indexes determined in step S503 performed 100 times is 75%. In this case, the participant state evaluation value is determined to be 75%.

In the example illustrated in FIG. 6, the participant state evaluation value is indicated as “⊚” (good), “∘” (normal), or “Δ” (bad). For example, a first threshold (e.g., 80%) and a second threshold (e.g., 20%) lower than the first threshold are used. Then, when the participant state evaluation value is equal to or more than the first threshold, the participant state evaluation value is determined to be “⊚.” When the participant state evaluation value is less than the first threshold and more than the second threshold, the participant state evaluation value is determined to be “∘.” When the participant state evaluation value is less than the second threshold, the participant state evaluation value is determined to be “Δ.”

In addition, the participant state may be an emotion of each participant of the meeting which is determined using the face API or the like as described above. In this case, the participant state evaluation value is determined based on the number of times of the detection of, for example, “joy” in the target time period. For example, when emotions of two participants are determined to be “joy” at the same time, the number of times of the detection of “joy” is counted up by two.

In addition, a first threshold (e.g., 10) and a second threshold (e.g., 5) lower than the first threshold are used. Then, when the number of times of the detection of “joy” is equal to or more than the first threshold, the participant state evaluation value is determined to be “⊚.” In addition, when the number of times of the detection of “joy” is less than the first threshold and equal to or more than the second threshold, the participant state evaluation value is determined to be “∘.” In addition, when the number of times of the detection of “joy” is less than the second threshold, the participant state evaluation value is determined to be “Δ.”

In addition, when the emotion of “anger” or “disgust” is detected once from at least one of participants of the meeting in the target time period, the participant state evaluation value may be determined to be “Δ,” and otherwise, the participant state evaluation value may be determined to be “∘.”

In addition, the participant state may be the state of whether each participant of the meeting is in the state of smiling face, which is determined using the Haar-Cascade or the like as described above. In this case, the participant state evaluation value is determined based on, for example, the number of times that the smiling face of a participant is detected in the target time period. For example, when two participants are determined to be in the state of smiling face at the same time, the number of times that the smiling face of a participant is detected is counted up by two.

In addition, a first threshold (e.g., 10) and a second threshold (e.g., 5) lower than the first threshold are used. Then, when the number of times that the smiling face of a participant is detected is equal to or more than the first threshold, the participant state evaluation value is determined to be “0.” In addition, when the number of times that the smiling face of a participant is detected is less than the first threshold and equal to or more than the second threshold, the participant state evaluation value is determined to be “∘.” In addition, when the number of times that the smiling face of a participant is detected is less than the second threshold, the participant state evaluation value is determined to be “Δ.”

In the meeting state determination table 600, the interval of description in the description area is a time taken after a previous object is described in the description area 111 until the next object is described. When the interval of description in the description area is short, this result indicates that the frequency of description in the description area 111 is high, and thus, the meeting state is close to “Diverge” or the like. When the interval of description in the description area is long, this result indicates that the frequency of description in the description area 111 is low, and thus, the meeting state is not close to “Diverge” or the like.

As described above, the target time period is discriminated at the timings of the start and the finish of description in the description area 111. Accordingly, when the target time period is a time period of non-description in the description area 111, the interval of description in the description area for the target time period is the time length of the target time period. In addition, when the target time period is a time period of description in the description area 111, the interval of description in the description area for the target time period is the time length of a time period immediately before the target time period (a time period of non-description).

In addition, since the meeting hardly diverges in the time period of description, the interval of description in the description area may not be determined when the target time period is the time period of description in the description area 111. In this case, the meeting state determining process based on the meeting state determination table 600 is performed by the combination of the speaker state evaluation value, the number of speakers, the number of speeches per time, and the participant state evaluation value. In addition, in this case, for example, the “Select/Define” and the “Share” are determined to be, for example, “Select/Define or Share” without being distinguished from each other.

In the example illustrated in FIG. 6, the interval of description in the description area is indicated as “long” or “short.” For example, when the interval of description in the description area is equal to or more than a predetermined threshold, the interval of description in the description area is determined to be “long,” and when the interval of description in the description area is less than the threshold, the interval of description in the description area is determined to be “short.”

As an example, the meeting state is determined to be “Diverge” for a time period when the speaker state evaluation value is “neutral, joy, or surprise,” the number of speakers is “many,” the number of speeches per time is “many,” the participant state evaluation value is “⊚,” and the interval of description in the description area is “short.” In addition, the meeting state is determined to be “Conflict” for a time period when the speaker state evaluation value is “anger or disgust,” the number of speakers is “small,” the number of speeches per time is “many,” the participant state evaluation value is “Δ,” and the interval of description in the description area is “long.”

### Description State Determining Process by the Facilitation Support Apparatus According to the Embodiment

FIGS. 7 to 9 are views illustrating an example of the description state determining process performed by the facilitation support apparatus according to the embodiment. For example, the facilitation support apparatus 120 extracts the description area 111 and a participant 101 who is performing a description in the description area 111, from the image represented by captured image data obtained by the board image capturing camera 201. The extraction of the description area 111 may be performed by an image matching based on, for example, the shape or color of the description area 111.

The extraction of the participant 101 may be performed by an image matching based on, for example, the shape or color of a person. In addition, when multiple persons are extracted from the image, the facilitation support apparatus 120 may extract, for example, a person present closest to the description area 111 as the participant 101 who is performing a description in the description area 111.

For example, the facilitation support apparatus 120 identifies persons who are not hidden by the description area 111 so as to identify persons present in front of the description area 111 (on the side of the board image capturing camera 201), among the persons included in the image. Then, the facilitation support apparatus 120 may identify a person present closest to the description area 111, among the identified persons, so as to extract the participant 101 who is performing a description in the description area 111.

The closeness between the description area 111 and a person present in front of the description area 111 may be compared based on, for example, the size of the person on the image. That is, it may be determined that as the size of a person on the image is small, the person is present inside (on the side of the description area 111).

In addition, when the board image capturing camera 201 is capable of measuring the distance to an image capturing target, the closeness between the description area 111 and a person may be compared based on the distance between a person on the image and the board image capturing camera 201. That is, it may be determined that as the distance between a person on the image and the board image capturing camera 201 is long, the person is present inside.

In addition, when persons overlap with each other, the closeness between the description area 111 and a person may be compared based on, for example, the overlapping between persons. That is, for example, when Messrs. A and B are present in front of the description area 111, and Mr. A is partially hidden by Mr. B, it may be determined that Mr. A is present inside as compared to Mr. B.

The facilitation support apparatus 120 extracts the head and the hand of the identified participant 101. The extraction of the head and the hand may be performed by an image matching based on, for example, the shape or color of the head and the hand of the person. Then, the facilitation support apparatus 120 calculates the distance between the extracted head and hand of the participant 101, and determines whether the participant 101 is performing a description in the description area 111, based on the calculated distance. For example, when the calculated distance is equal to or more than a threshold, the facilitation support apparatus 120 determines that the participant 101 is performing a description in the description area 111. In addition, when the calculated distance is less than the threshold, the facilitation support apparatus 120 determines that the participant 101 is not performing a description in the description area 111 (non-description).

In addition, when the board image capturing camera 201 is capable of measuring the distance to an image capturing target, the facilitation support apparatus 120 may calculate a difference between the distance to the description area 111 and the distance to the person present closest to the description area 111. As a result, the distance between the description area 111 and the person present closest to the description area 111 may be calculated. Then, when the calculated distance is equal to or more than a threshold, the facilitation support apparatus 120 may determine that there is no participant who is performing a description in the description area 111, and determine that the participant 101 is not performing a description in the description area 111.

An extracted area 701 illustrated in FIGS. 7 to 9 is an area of the head of the participant 101 that has been extracted by the facilitation support apparatus 120. An extracted area 702 illustrated in FIGS. 7 to 9 is an area of the hand of the participant 101 that has been extracted by the facilitation support apparatus 120. In the example illustrated in FIGS. 7 and 8, since the distance between the extracted areas 701 and 702 is short, the facilitation support apparatus 120 determines that the participant 101 is performing a description in the description area 111. Meanwhile, in the example illustrated in FIG. 9, since the distance between the extracted areas 701 and 702 is long, the facilitation support apparatus 120 determines that the participant 101 is not performing a description in the description area 111.

When the state of FIG. 7 or 8 is changed to the state of FIG. 9, the facilitation support apparatus 120 determines that the description is finished. Then, the facilitation support apparatus 120 extracts an updated area from the image represented by the captured image data obtained by the board image capturing camera 201, so as to extract an object #1 of which description is finished at this time.

For example, when no described object has been generated until the current time, the facilitation support apparatus 120 extracts a difference between the image of the description area 111 in the initial state of the meeting and the image of the description area 111 at the current time. As a result, the object #1 may be extracted. The image of the description area 111 is an image based on a captured image data which is obtained by the board image capturing camera 201.

In addition, when a described object has been generated until the current time, the facilitation support apparatus 120 extracts an image of a difference between the image of the description area 111 in the initial state of the meeting and the image of the description area 111 at the current time. Then, the facilitation support apparatus 120 excludes the object corresponding to the generated described object, from the extracted image of the difference. As a result, the object #1 may be extracted.

In the process of extracting the object #1, the facilitation support apparatus 120 performs each determination while excluding an area of a person such as the participant 101 from the image represented by the captured image data obtained by the board image capturing camera 201.

### Processes Accompanied by the Progress of the Meeting in the Facilitation Support Apparatus According to the Embodiment

Subsequently, an example of the progress of the meeting and processes performed by the facilitation support apparatus 120 in the example will be described with reference to FIGS. 10 to 29. In this example, it is assumed that five persons of Messrs. A, B, C, D, and E are participating in the meeting. Further, in this example, it is assumed that nothing is described in the description area 111 at the time of the start of the meeting, and Mr. A describes at least three objects (objects #1 to #3 to be described later) in the description area 111 during the meeting.

FIGS. 10 and 11 are views illustrating a first stage in an example of a target meeting of the facilitation support apparatus according to the embodiment. FIG. 12 is a view illustrating an example of timings of processes performed by the facilitation support apparatus in the first stage illustrated in FIGS. 10 and 11. FIG. 13 is a view illustrating an example of information stored in the object information storage by the facilitation support apparatus in the first stage illustrated in FIGS. 10 and 11.

In FIG. 12, the horizontal axis represents a timing. A description state 1201 is the state of description in the description area 111 which is determined by the above-described description state determining process started in step S501 illustrated in FIGS. 5A and 5B, and is either non-description or description. A speaker 1202 is a speaker detected by the above-described speaker detecting process started in step S501 illustrated in FIGS. 5A and 5B for each time period discriminated by a change of the description state 1201 (the start of description and the finish of description).

A meeting state 1203 is a meeting state determined by the above-described meeting state determining process in step S506 illustrated in FIGS. 5A and 58. A stored voice data 1204 is voice data that is obtained by the microphone 203 and stored in the voice data storage 405 by the above-described voice data storing process started in step S501 illustrated in FIGS. 5A and 58. A chapter number 1205 is a number indicating a chapter set in voice data in step S505 illustrated in FIGS. 5A and 58.

A description state change timing 1206 is a timing of the change of the description state 1201 of which presence/absence is determined in step S504 illustrated in FIGS. 5A and 5B. The description state change timing 1206 includes the start of description and the finish of description as described above. A description finish timing 1207 is a timing of the finish of description included in the description state change timing 1206. A described object generation timing 1208 is a timing when a described object is generated in step S511 illustrated in FIGS. 5A and 5B.

First, as illustrated in FIG. 10, it is assumed that the meeting is started at a timing t0 simultaneously with the start of the information storing process illustrated in FIGS. 5A and 58 by the facilitation support apparatus 120, and Messrs. A, B, and C speak. At this time, as represented in the stored voice data 1204 of FIG. 12, the facilitation support apparatus 120 starts storing “Voice_1” which is voice data obtained by the microphone 203. At this time, as represented in the chapter number 1205 of FIG. 12, the facilitation support apparatus 120 sets a chapter number “0” at the position corresponding to the timing t0 in “Voice_1.”

Subsequently, as illustrated in FIG. 11, it is assumed that at a timing t1, Mr. A starts describing an object #1 (a bar graph) in the description area 111. In this case, as represented in the description state 1201 of FIG. 12, the time period from the timing t0 to the timing t1 corresponds to the time period of non-description. At this time, as represented in the description state change timing 1206 of FIG. 12, the facilitation support apparatus 120 determines that the state of description in the description area 111 has been changed, in step S504 illustrated in FIGS. 5A and 5B.

In addition, as represented in the speaker 1202 of FIG. 12, the facilitation support apparatus 120 detects Messrs. A, B, and C as speakers in the time period from the timing t0 to the timing t1. Further, as represented in the meeting state 1203 of FIG. 12, the facilitation support apparatus 120 determines the meeting state in the time period from the timing t0 to the timing t1. Here, it is assumed that the facilitation support apparatus 120 determines the meeting state to be “meeting state_1.” In addition, as represented in the chapter number 1205 of FIG. 12, the facilitation support apparatus 120 sets a chapter number “1” at the position corresponding to the timing t1 in “Voice_1.”

Further, the facilitation support apparatus 120 generates temporary information 1310 as illustrated in FIG. 13, and stores the temporary information 1310 in the object information storage 407. The temporary information 1310 is information in the time period from the timing t0 to the timing t1. For example, the temporary information 1310 indicates Messrs. A, B, and C as speakers, indicates “meeting state_1” as a meeting state, and indicates “0” as a chapter number.

FIGS. 14 and 15 are views illustrating a second stage in the example of the target meeting of the facilitation support apparatus according to the embodiment. FIG. 16 is a view illustrating an example of timings of processes performed by the facilitation support apparatus in the second stage illustrated in FIGS. 14 and 15. FIG. 17 is a view illustrating an example of information stored in the object information storage by the facilitation support apparatus in the second stage illustrated in FIGS. 14 and 15.

It is assumed that after the first stage illustrated in FIGS. 10 and 11, Mr. B speaks while Mr. A is description the object #1 in the description area 111 as illustrated in FIG. 14. Subsequently, it is assumed that Mr. A finishes the description of the object #1 in the description area 111 at a timing t2 as illustrated in FIG. 15. In this case, as represented in the description state 1201 of FIG. 16, the time period from the timing t1 to the timing t2 corresponds to the time period of description.

At this time, as represented in the stored voice data 1204 of FIG. 16, the facilitation support apparatus 120 continues the storage of “Voice_1” started from the first stage. In addition, as represented in the speaker 1202 of FIG. 16, the facilitation support apparatus 120 detects Mr. B as a speaker in the time period from the timing t1 to the timing t2.

Further, as represented in the meeting state 1203 of FIG. 16, the facilitation support apparatus 120 determines the meeting state in the time period from the timing t1 to the timing t2. Here, it is assumed that the facilitation support apparatus 120 determines the meeting state to be “meeting state_2.” In addition, as represented in the chapter number 1205 of FIG. 16, the facilitation support apparatus 120 sets a chapter number “2” at the position corresponding to the timing t2 in “Voice_1.”

Further, as illustrated in FIG. 17, the facilitation support apparatus 120 generates a described object 1710, object management information 1720, and attribute information 1730, and stores the generated information in the object information storage 407. The described object 1710 is image data representing the object #1 of which description has been finished at the timing t2.

The object management information 1720 is information that indicates a description position and a storage address for each object described in the description area 111 in one target meeting. The description position is a description position where a target object is described, in the description area (e.g., XY coordinates). The storage address is an address where a described object indicating a target object is stored, in the object information storage 407 (the memory 302). As illustrated in FIG. 17, in the first stage, the object management information 1720 indicates the description position “x1, y1” and the storage address “address_1” of the object #1 of which description has been finished at the timing t2.

Further, the object management information 1720 is information that may identify a description order of each object by storing information of each object in an order in which the object is described. Here, since the information of the object #1 is stored at the top of the object management information 1720, the object #1 may be identified as an object described for the first time.

The attribute information 1730 is information that indicates a speaker, a meeting state, and a chapter number for each of the time periods of before the description of the object #1 (the timing t0 to the timing t1), during the description of the object #1 (the timing t1 to the timing t2), and after the description of the object #1. As illustrated in FIG. 17, in the first stage, the attribute information 1730 indicates Messrs. A, B, and C as speakers in the time period of before the description, indicates “meeting state_1” as a meeting state in the time period of before the description, and indicates “0” as a chapter number in the time period before the description. The respective pieces of information of the time period of before the description are generated based on the temporary information 1310 illustrated in FIG. 13.

Further, in the first stage, the attribute information 1730 indicates Mr. B as a speaker in the time period of before the description, indicates “meeting state_2” as a meeting state in the time period of during the description, and indicates “1” as a chapter number in the time period of during the description. The respective pieces of information of the time period of during the description are generated based on the respective pieces of information determined and temporarily stored in the time period from the timing t1 to the timing t2.

Further, in the first stage, the time period of after the description of the object #1, that is, the time period from the finish of the description of the object #1 to the start of the description of the object #2 is not determined. Thus, the information in the time period of after the description in the attribute information 1730 is blank. Further, as illustrated in FIG. 17, the facilitation support apparatus 120 dears the temporary information 1310 illustrated in FIG. 13 from the object information storage 407.

FIGS. 18 and 19 are views illustrating a third stage in the example of the target meeting of the facilitation support apparatus according to the embodiment. FIG. 20 is a view illustrating an example of timings of processes performed by the facilitation support apparatus in the third stage illustrated in FIGS. 18 and 19. FIG. 21 is a view illustrating an example of information stored in the object information storage by the facilitation support apparatus in the third stage illustrated in FIGS. 18 and 19.

It is assumed that after the second stage illustrated in FIGS. 14 and 15, Messrs. A, B, C, and D speak as illustrated in FIG. 18. Subsequently, it is assumed that as illustrated in FIG. 19, Mr. A starts the description the object #2 (a drawing of a notebook PC) in the description area 111 at a timing t3. In this case, as represented in the description state 1201 of FIG. 20, the time period from the timing t2 to the timing t3 corresponds to the time period of non-description.

At this time, the facilitation support apparatus 120 continues the storage of “Voice_1” started from the first stage as represented in the stored voice data 1204 of FIG. 20. In addition, as represented in the speaker 1202 of FIG. 20, the facilitation support apparatus 120 detects Messrs. A, B, C, and D as speakers in the time period from the timing t2 to the timing t3.

Further, as represented in the meeting state 1203 of FIG. 20, the facilitation support apparatus 120 determines the meeting state in the time period from the timing t2 to the timing t3. Here, it is assumed that the facilitation support apparatus 120 determines the meeting state to be “meeting state_3.” In addition, as represented in the chapter number 1205 of FIG. 20, the facilitation support apparatus 120 sets a chapter number “3” at the position corresponding to the timing t3 in “Voice_1.”

Further, as illustrated in FIG. 21, the facilitation support apparatus 120 generates temporary information 2110 and stores the temporary information 2110 in the object information storage 407. The temporary information 2110 is information in the time period from the timing t2 to the timing t3. For example, the temporary information 2110 indicates Messrs. A, B, C, and D as speakers, indicates “meeting state_3” as a meeting state, and indicates “2” as a chapter number.

Further, as illustrated in FIG. 21, the facilitation support apparatus 120 adds the same contents as the temporary information 2110 as information of the time period of after the description of the object #1 (timings t2 to t3) to the attribute information 1730. As a result, the attribute information 1730 related to the object #1 is completed.

FIGS. 22 and 23 are views illustrating a fourth stage in the example of the target meeting of the facilitation support apparatus according to the embodiment. FIG. 24 is a view illustrating an example of timings of processes performed by the facilitation support apparatus in the fourth stage illustrated in FIGS. 22 and 23. FIG. 25 is a view illustrating an example of information stored in the object information storage by the facilitation support apparatus in the fourth stage illustrated in FIGS. 22 and 23.

It is assumed that after the third stage illustrated in FIGS. 18 and 19, Mr. B speaks while Mr. A describes the object #2 In the description area 111 as illustrated in FIG. 22. Subsequently, it is assumed that as illustrated in FIG. 23, Mr. A finishes the description of the object #2 in the description area 111 at a timing t4. In this case, as represented in the description state 1201 of FIG. 24, the time period from the timing t3 to the timing t4 corresponds to the time period of description.

At this time, the facilitation support apparatus 120 continues the storage of “Voice_1” started from the first stage as represented in the stored voice data 1204 of FIG. 24. In addition, as represented in the speaker 1202 of FIG. 24, the facilitation support apparatus 120 detects Mr. B as a speaker in the time period from the timing t3 to the timing t4.

Further, as represented in the meeting state 1203 of FIG. 24, the facilitation support apparatus 120 determines the meeting state in the time period from the timing t3 to t4. Here, it is assumed that the facilitation support apparatus 120 determines the meeting state to be “meeting state_4.” In addition, as represented in the chapter number 1205 of FIG. 24, the facilitation support apparatus 120 sets a chapter number “4” at the position corresponding to the timing t4 in “Voice_1.”

Further, as illustrated in FIG. 25, the facilitation support apparatus 120 generates a described object 2510 and attribute information 2530, and stores the generated information in the object information storage 407. The described object 2510 is image data representing the object #2 of which description has been finished at the timing t4.

The attribute information 2530 is information that indicates a speaker, a meeting state, and a chapter number for each of the time periods of before the description of the object #2 (the timings t2 to t3), during the description of the object #2 (the timings t3 to t4), and after the description of the object #2. As illustrated in FIG. 25, in the fourth stage, the attribute information 2530 indicates Messrs. A, B, C, and D as speakers in the time period before the description, indicates “meeting state_3” as a meeting state in the time period of before the description, and indicates “2” as a chapter number in the time period of before the description. The respective pieces of information of the time period of before the description are generated based on the temporary information 2110 illustrated in FIG. 21.

Further, in the fourth stage, the attribute information 2530 indicates Mr. B as a speaker in the time period of during the description, indicates “meeting state_4” as a meeting state in the time period of during the description, and indicates “4” as a chapter number in the time period of during the description. The respective pieces of information of the time period of during the description are generated based on the respective pieces of information determined and temporarily stored in the time period from the timing t3 to the timing t4.

Further, in the fourth stage, the time period after the description of the object #2, that is, the time period from the finish of the description of the object #2 to the start of the description of the object #3 is not determined. Thus, the information of the time period of after the description in the attribute information 2530 is blank. Further, as illustrated in FIG. 25, the facilitation support apparatus 120 dears the temporary information 2110 illustrated in FIG. 21 from the object information storage 407.

Further, as illustrated in FIG. 25, the facilitation support apparatus 120 adds the information of the object #2 to the object management information 1720 of the object information storage 407. As illustrated in FIG. 25, in the fourth stage, the object management information 1720 indicates the description position “x2, y2” and the storage address “address_2” of the object #2 of which description has been finished at the timing t4, in addition the information of the object #1 described above. The storage address “address_2” is an address where the described object 2510 indicating the object #2 is stored, in the object information storage 407 (the memory 302).

FIGS. 26 and 27 are views illustrating a fifth stage in the example of the target meeting of the facilitation support apparatus according to the embodiment. FIG. 28 is a view illustrating an example of timings of processes performed by the facilitation support apparatus in the fifth stage illustrated in FIGS. 26 and 27. FIG. 29 is a view illustrating an example of information stored in the object information storage by the facilitation support apparatus in the fifth stage illustrated in FIGS. 26 and 27.

It is assumed that after the fourth stage illustrated in FIGS. 22 and 23, Messrs. A and D speak as illustrated in FIG. 26. Subsequently, it is assumed that as illustrated in FIG. 27, Mr. A starts the description of the object #3 in the description area 111 at a timing t5. In this case, as represented in the description state 1201 of FIG. 28, the time period from the timing t4 to the timing t5 corresponds to the time period of non-description.

At this time, the facilitation support apparatus 120 continues the storage of “Voice_1” started from the first stage as represented in the stored voice data 1204 of FIG. 28. In addition, as represented in the speaker 1202 of FIG. 28, the facilitation support apparatus 120 detects Messrs. A and D as speakers in the time period from the timing t4 to the timing t5.

Further, as represented in the meeting state 1203 of FIG. 28, the facilitation support apparatus 120 determines the meeting state in the time period from the timing t4 to the timing t5. Here, it is assumed that the facilitation support apparatus 120 determines the meeting state to be “meeting state_5.” In addition, as represented in the chapter number 1205 of FIG. 28, the facilitation support apparatus 120 sets a chapter number “5” at the position corresponding to the timing t5 in “Voice_1.”

Further, as illustrated in FIG. 29, the facilitation support apparatus 120 generates temporary information 2910 and stores the temporary information 2910 in the object information storage 407. The temporary information 2910 is information in the time period from the timing t4 to the timing t5. For example, the temporary information 2910 indicates Messrs. A and D as speakers, indicates “meeting state_5” as a meeting state, and indicates “4” as a chapter number.

Further, as illustrated in FIG. 29, the facilitation support apparatus 120 adds the same contents as the temporary information 2910 as information of the time period of after the description of the object #2 (timings t4 to t5) to the attribute information 2530. As a result, the attribute information 2530 related to the object #2 is completed.

In the examples illustrated in FIGS. 5A, 58B, and 10 to 29, the respective pieces of information on an object are generated during the progress of the meeting, that is, during the storage of recorded data. However, the present disclosure is not limited to this process. For example, the captured image data which are obtained by the board image capturing camera 201 and the participant image capturing camera 202, and the voice data which is obtained by the microphone 203 may be stored for the entire time period of the meeting. In this case, the facilitation support apparatus 120 generates the same respective pieces of information as those generated by the above-described information outputting process, on an object based on the stored captured image data and voice data after the end of the meeting.

### Information Outputting Process by the Facilitation Support Apparatus According to the Embodiment

FIG. 30 is a flowchart illustrating an example of the information outputting process performed by the facilitation support apparatus according to the embodiment. When the meeting using the whiteboard 110 is ended, and then, an operation to instruct an output of information on the meeting is received, the facilitation support apparatus 120 according to the embodiment starts the information outputting process illustrated in, for example, FIG. 30. The information outputting process illustrated in FIG. 30 is executed by the output controller 408 illustrated in, for example, FIG. 4.

First, the facilitation support apparatus 120 displays each object described in the description area 111 in the target meeting (step S3001). For example, the facilitation support apparatus 120 displays each object described in the description area 111 based on the object management information 1720 and each described object which are stored in the object information storage 407 (see, e.g., FIG. 31). In addition, for example, the facilitation support apparatus 120 performs the display of step S3001 by outputting the information to be displayed, to a display included in the user interface 305 described above.

Next, the facilitation support apparatus 120 receives a designation of one of the objects displayed in step S3001 from the user (step S3002). An example of the method of receiving a designation of an object will be described later (see, e.g., FIGS. 32 to 34).

Next, the facilitation support apparatus 120 identifies a speaker and a meeting state in each of the time periods of before, during, and after the description of the object of which designation has been received in step S3002 (step S3003). For example, the facilitation support apparatus 120 performs the identifying process of step S3003 based on the attribute information stored in the object information storage 407 on the object of which designation has been received. As described above, the attribute information includes information of a speaker and a meeting state in each of the time periods of before, during, and after the description of the target object.

Next, the facilitation support apparatus 120 displays the speaker and the meeting state identified in step S3003 in association with each of the time periods of before, during, and after the description of the object of which designation has been received as described above (step S3004). For example, the facilitation support apparatus 120 performs the display of step S3004 by outputting the information to be displayed, to the display included in the user interface 305 described above (see, e.g., FIGS. 32 to 34).

Next, the facilitation support apparatus 120 receives a designation of one of the time periods of before, during, and after the description which are displayed in step S3004, from the user (step S3005). An example of the method of receiving a designation of a time period will be described later (see, e.g., FIGS. 31 to 34).

Next, the facilitation support apparatus 120 identifies voice of the time period of which designation has been received in step S3005, among the voices represented by the voice data stored in the voice data storage 405 (step S3006). For example, the facilitation support apparatus 120 identifies a chapter number corresponding to the time period of which designation has been received, among the chapter numbers set in the voice data stored in the voice data storage 405, based on the attribute information stored in the object information storage 407. As described above, the attribute information includes a chapter number of voice data in each of the time periods of before, during, and after the description of the target object.

Next, the facilitation support apparatus 120 reproduces the voice identified in step S3006 based on the voice data stored in the voice data storage 405 (step S3007), and ends the series of steps of the information outputting process. For example, the facilitation support apparatus 120 reproduces the voice represented by the voice data stored in the voice data storage 405, starting from the chapter indicated by the chapter number identified in step S3006. In addition, for example, the facilitation support apparatus 120 performs the reproduction of step S3007 by outputting the information to a speaker included in the user interface 305 as described above.

### Object Reproduction Screen Displayed by the Facilitation Support Apparatus According to the Embodiment

FIG. 31 is a view illustrating an example of an object reproduction screen displayed by the facilitation support apparatus according to the embodiment. Here, it is assumed that objects #11 to #14 were described in this order in the description area 111 in a meeting performed once in the past.

The facilitation support apparatus 120 performs the information storing process illustrated in FIGS. 5A and 5B on the meeting, and as a result, stores voice data representing voices recorded in the meeting in the voice data storage 405.

Further, the facilitation support apparatus 120 stores the respective pieces of information on the objects #11 to #14 in the object information storage 407. Here, the facilitation support apparatus 120 may store information that may identify the description order of the objects #11 to #14. For example, in the object management information 1720 described above, the information on the object #11, the information on the object #12, the information on the object #13, and the information on the object #14 are stored in this order.

For example, when an instruction is received to display the object reproduction screen 3100 on the meeting, the facilitation support apparatus 120 acquires the respective pieces of information of the objects #11 to #14 stored in the object information storage 407. Then, the facilitation support apparatus 120 displays the object reproduction screen 3100 including the objects #11 to #14, based on the acquired respective pieces of information. The object reproduction screen 3100 is displayed by a display or the like included in the user interface 305 illustrated in, for example, FIG. 3.

For example, the facilitation support apparatus 120 reads a target described object by referring to the above-described storage address in the object management information 1720 for each of the objects #11 to #14 included in the object management information 1720. Then, the facilitation support apparatus 120 depicts the object indicated by the read described object at the position indicated by the above-described description position in the object management information 1720. As a result, the object reproduction screen 3100 including the objects #11 to #14 is displayed, and the contents described in the description area 111 in the target meeting are reproduced.

A cursor 3111 is a pointer that is superimposed on the object reproduction screen 3100 and may be operated by the user. For example, the cursor 3111 may be operated by the user using a mouse or the like included in the user interface 305 illustrated in FIG. 3.

### Display of Sub-Window by the Facilitation Support Apparatus According to the Embodiment

FIG. 32 is a view illustrating an example of a display of a sub-window by the facilitation support apparatus according to the embodiment. In FIG. 32, portions similar to those illustrated in FIG. 31 will be denoted by the same reference numerals as used in FIG. 31, and descriptions thereof will be omitted. For example, it is assumed that in the state illustrated in FIG. 31, the user operates the cursor 3111 using a mouse or the like to place (mouse) the cursor 3111 on the object #13 as illustrated in FIG. 32. Alternatively, it is assumed that the user performs an instruction operation (e.g., clicking the button of the mouse) in a state where the cursor 3111 is placed on the object #13.

In this case, the facilitation support apparatus 120 determines that an instruction of the object #13 has been received. Then, the facilitation support apparatus 120 acquires the attribute information on the object #13 from the object information storage 407, and displays a sub-window 3210 based on the acquired attribute information in a pop-up form.

The sub-window 3210 is displayed at a position that does not overlap with the display area of the object #13. In the example illustrated in FIG. 32, the sub-window 3210 is displayed at the right lower portion of the object #13. The sub-window 3210 displays a speaker 3212 and a meeting state 3213 for each of the time periods of before, during, and after the description of the object #13. Further, in the example illustrated in FIG. 32, the sub-window 3210 also displays the above-described participant state together with the meeting state 3213.

From the sub-window 3210, the user may identify a time period when a specific participant speaks, among the time periods of before, during, and after the description of the object #13, with respect to the object #13. Further, the user may identify a time period when the meeting state or participant state becomes a specific meeting state or participant state, among the time periods of before, during, and after the description of the object #13, with respect to the object #13.

In addition, the sub-window 3210 includes reproduction buttons 3211a to 3211c. The reproduction buttons 3211a to 3211c are to reproduce the voice data in the time periods of before, during, and after the description of the object #13, respectively. The reproduction of voice data is performed by a speaker included in the user interface 305 illustrated in, for example, FIG. 3.

For example, when the reproduction button 3211a that corresponds to the time period of before the description is instructed (e.g., clicked) by the cursor 3111, the facilitation support apparatus 120 acquires the chapter number of the time period of before the description from the attribute information on the object #13 in the object information storage 407. Then, the facilitation support apparatus 120 reproduces the voice data of the voice data storage 405, starting from the position (chapter) indicated by the acquired chapter number.

In addition, when the reproduction button 3211b that corresponds to the time period of during the description is instructed by the cursor 3111, the facilitation support apparatus 120 acquires the chapter number of the time period of during the description from the attribute information on the object #13 in the object information storage 407. Then, the facilitation support apparatus 120 reproduces the voice data of the voice data storage 405, starting from the position (chapter) indicated by the acquired chapter number.

In addition, when the reproduction button 3211c that corresponds to the time period of after the description is instructed by the cursor 3111, the facilitation support apparatus 120 acquires the chapter number of the time period of after the description from the attribute information on the object #13 in the object information storage 407. Then, the facilitation support apparatus 120 reproduces the voice data of the voice data storage 405, starting from the position (chapter) Indicated by the acquired chapter number.

When the voice data is reproduced starting from the position indicated by the acquired chapter number, the facilitation support apparatus 120 stops the reproduction of the voice data at, for example, a position where the next chapter number is set. Alternatively, when the voice data is reproduced starting from the position indicated by the acquired chapter number, the facilitation support apparatus 10 may reproduce the voice data to the end of the voice data.

For example, when the user desires to identify Mr. A's speech on the object #13, the user places the cursor 3111 on the object #13 such that the sub-window 3210 is displayed. As a result, the user may identify from the sub-window 3210 that the speakers in the time period of before the description of the object #13 Include Mr. A. In this case, the user instructs the reproduction button 3211a that corresponds to the time period of before the description, using the cursor 3111. As a result, among the voices represented by the voice data of the voice data storage 405, the voice in the time period when Mr. A speaks on the object #13 is reproduced.

Alternatively, when the user desires to identify voice of the meeting when a conflict occurs on the object #13 in the meeting, the user places the cursor 3111 on the object #13 such that the sub-window 3210 is displayed. As a result, the user may identify from the sub-window 3210 that the meeting state of the time period of after the description of the object #13 is the state of Conflict. In this case, the user instructs the reproduction button 3211c that corresponds to the time period of after the description, using the cursor 3111. As a result, among the voices represented by the voice data of the voice data storage 405, the voice of the time period during which the conflict occurs on the object #13 in the meeting is reproduced.

In addition, the sub-window 3210 includes a close button 3214. When the close button 3214 is instructed by the cursor 3111, the sub-window 3210 is hidden.

When the cursor 3111 is placed on the object #13, the facilitation support apparatus 120 may display a frame 3223 that surrounds the object #13 (a solid rectangular frame in the example illustrated in FIG. 32). As a result, the user may easily identify that the object #13 is selected, and the sub-window 3210 related to the object #13 is being displayed.

In addition, when the cursor 3111 is placed on the object #13, the facilitation support apparatus 120 may display a frame 3222 that surrounds the object #12 described before the object #13 (a dashed-line rectangular frame in the example illustrated in FIG. 32). In addition, the facilitation support apparatus 120 may display an arrow 3231 directed from the frame 3222 that surrounds the object #12 toward the frame 3223 that surrounds the object #13 (a dashed-line arrow in the example illustrated in FIG. 32). As a result, the user may easily identify that the object #12 is the object described before the object #13 on which the cursor 3111 is placed. Thus, the user may easily identify the flow of the meeting.

In addition, when the cursor 3111 is placed on the object #13, the facilitation support apparatus 120 may display a frame 3224 that surrounds the object #14 described next to the object #13 (a dashed-line rectangular frame in the example illustrated in FIG. 32). In addition, the facilitation support apparatus 120 may display an arrow 3232 directed from the frame 3223 that surrounds the object #13 toward the frame 3224 that surrounds the object #14 (a solid-line arrow in the example illustrated in FIG. 32). As a result, the user may easily identify that the object #14 is the object described next to the object #13 on which the cursor 3111 is placed.

Descriptions have been made on a case where the frames 3222 and 3223 are used to highlight the objects #12 and #13. However, without limiting to the frames, the objects #12 and #13 may be highlighted by various methods such as changing the background color or reversing the display.

FIG. 33 is a view (part 1) illustrating another example of the display of the sub-window by the facilitation support apparatus according to the embodiment. In FIG. 33, portions similar to those illustrated in FIG. 32 will be denoted by the same reference numerals as used in FIG. 31, and descriptions thereof will be omitted. When an instruction to display the object reproduction screen 3100 is received, the facilitation support apparatus 120 may display the object reproduction screen 3100 including a list window 3310 as illustrated in FIG. 33.

The list window 3310 is a window in which an object may be selected and instructed from the meeting state or the speaker. For example, the list window 3310 displays “∇Meeting state” and “∇Speaker” in the initial state. Here, for example, when the “∇Meeting state” is instructed by the cursor 3111, “∇Diverge,” “∇Converge,” “∇Select/Define,” “∇Share,” and “∇Conflict” are displayed as illustrated in FIG. 33.

Then, for example, when the “∇Diverge” is instructed by the cursor 3111, the list window 3310 displays each object that includes “Diverge” as the meeting state of at least one of the time periods of before, during, and after the description. In the example illustrated in FIG. 33, the list window 3310 displays the objects #12 and #13. Then, for example, when the cursor 3111 is placed on the object #13 displayed in the list window 3310, the facilitation support apparatus 120 displays the above-described sub-window 3210 related to the object #13 in the pop-up form.

As a result, the user may easily select the object including a specific meeting state at the time of the description, to display information indicating a speaker and a meeting state in each of the time periods of before, during, and after the description of the object (e.g., the sub-window 3210).

FIG. 34 is a view (part 2) illustrating yet another example of the display of the sub-window by the facilitation support apparatus according to the embodiment. In FIG. 34, portions similar to those illustrated in FIG. 33 will be denoted by the same reference numerals as used in FIG. 33, and descriptions thereof will be omitted. As described above, the list window 3310 displays “∇Meeting state” and “∇Speaker” in the initial state.

Here, for example, when the “∇Speaker” is instructed by the cursor 3111, the list window 3310 displays “Mr. A,” “Mr. B,” “Mr. C,” and “Mr. D” who are participants of the meeting corresponding to the objects #11 to #14 as illustrated in FIG. 34.

Then, for example, when “Mr. C” is instructed by the cursor 3111, the list window 3310 displays each object that includes Mr. C in the speaker of at least one of the time periods of before, during, and after the description. In the example illustrated in FIG. 34, the list window 3310 displays the objects #11 and #13. Then, for example, when the cursor 3111 is placed on the object #13 displayed in the list window 3310, the facilitation support apparatus 120 displays the above-described sub-window 3210 related to the object #13 in the pop-up form.

As a result, the user may easily select the object on which a specific speaker speaks, to display information indicating a speaker and a meeting state in each of the time periods of before, during, and after the description of the object (e.g., the sub-window 3210).

In this way, the facilitation support apparatus 120 according to the embodiment outputs information that may identify a speaker in each of the time periods of before, during, and after the description of a designated object among objects described on a board. Then, the facilitation support apparatus 120 outputs voice in a designated time period of the above-described time periods, among voices recorded in the above-described discussion.

As a result, the user may identify a speaker in each of the time periods of before, during, and after the description of the designated object, and refer to voice in the designated time period based on the identified speaker. Accordingly, the user may easily find and refer to a speech of a desired participant (e.g., a stakeholder of a meeting) on a desired object described on the board in the discussion, from the voices recorded in the discussion. That is, the user may quickly hear a speech of a desired participant on a desired object. As a result, a speech of a desired participant on a desired object described on the board is easily identified so that the facilitation may be supported. The speech to be identified includes contents or nuance (e.g., tone) of the speech.

In addition, the facilitation support apparatus 120 may perform a process of storing information that may identify a speaker in each of the time periods of before, during, and after a description of an object, in the first storage described above. For example, the facilitation support apparatus 120 monitors whether a participant of a discussion is performing a description on the board. Then, the facilitation support apparatus 120 extracts an object described on the board based on the monitoring result and an image obtained in the discussion to represent the contents described on the board. Further, the facilitation support apparatus 120 detects a speaker in each of the time periods of before, during, and after the description of the extracted object based on the voices recorded in the discussion. Then, based on the detected speaker, the facilitation support apparatus 120 stores information that may identify the speaker in each of the time periods of before, during, and after the description of the extracted object, in the first storage.

In addition, the facilitation support apparatus 120 may monitor whether a participant is performing a description on the board in each time of the discussion, based on, for example, the distance between the head and the hand of a participant in the discussion which is determined from the captured image data. As an example, when the distance between the head and the hand of a participant is equal to or more than a predetermined threshold, the facilitation support apparatus 120 determines that the participant is performing a description on the board. In addition, when the distance between the head and the hand of a participant is less than the threshold, the facilitation support apparatus 120 determines that the participant is not performing a description on the board.

Each of the above-described time periods of before, during, and after a description of an object may be a time period obtained by discriminating the time period of the meeting by the timings of the start and the finish of the description of the object, based on the result of the monitoring of whether a participant is performing a description.

In addition, the first storage described above may further store information that may identify a discussion state in each of the time periods of before, during, and after a description of an object on the board in the discussion, in association with the object. The discussion state is, for example, the above-described meeting state (e.g., “Diverge,” “Converge,” “Select/Define,” “Share” or “Conflict”). The facilitation support apparatus 120 refers to the first storage, and outputs information that may identify a discussion state in each of the time periods of before, during, and after the description of a designated object.

As a result, the user may identify the discussion state in each of the time periods of before, during, and after the description of the designated object, and refer to voice in a designated time period based on the identified discussion state. Accordingly, the user may easily find and refer to voice in a specific discussion state on a specific object described on the board, from the voices recorded in the discussion. Thus, a speech on an object described on the board is easily identified so that the facilitation may be supported.

The discussion state in a specific time period is, for example, a state determined using a state related to an emotion of a speaker in the corresponding time period of the discussion (e.g., the speaker state evaluation value described above using FIG. 6), as an index. In addition, the discussion state in a specific time period may be a state determined using the number of speakers in the corresponding time period of the discussion (e.g., the number of speakers described above using FIG. 6), as an index.

In addition, the discussion state in a specific time period may be a state determined using the number of speeches per time in the corresponding time period of the discussion (e.g., the number of speeches per time described above using FIG. 6), as an index. In addition, the discussion state in a specific time period may be a state determined using a state related to an emotion of a participant in the corresponding time period of the discussion (e.g., the participant state evaluation value described above using FIG. 6), as an index.

In addition, the discussion state in a specific time period may be a state determined using the time length of the corresponding time period (e.g., the interval of description in the description area as described above using FIG. 6), as an index. In addition, the discussion state in a specific time period may be a state determined using a combination of information of the above-described indexes.

In addition, the facilitation support apparatus 120 may receive a designation of the above-described discussion state before a designation of an object is received (see, e.g., FIG. 33). In this case, the facilitation support apparatus 120 identifies an object that includes the time period of the designated state in at least one of the time periods of before, during, and after the description, among objects described on the board in the discussion. Then, the facilitation support apparatus 120 outputs information that may identify the identified object. As a result, the use may easily designate the object described when the discussion becomes a specific state.

In addition, the facilitation support apparatus 120 may receive a designation of a speaker of a discussion before a designation of an object is received (see, e.g., FIG. 34). In this case, the facilitation support apparatus 120 identifies an object that includes the time period when the designated participant speaks in at least one of the time periods of before, during, and after the description, among objects described on the board in the discussion. Then, the facilitation support apparatus 120 outputs the information that may identify the identified object. As a result, the user may easily designate the object described when a specific participate speaks.

In addition, when an object is designated from objects described on the board in the discussion, the facilitation support apparatus 120 may perform the following process. That is, the facilitation support apparatus 120 identifies at least one of an object described on the board immediately before the designated object and an object described on the board immediately after the designated object. Then, the facilitation support apparatus 120 outputs the information that may identify the identified object (e.g., the frames 3222 and 3224 or the arrows 3231 and 3232 illustrated in FIGS. 32 to 34) (see, e.g., FIGS. 32 to 34).

As a result, the user may easily identify the objects before and after the designated object. Thus, the user may easily identify the description order of the objects.

In the above-described embodiment, the whiteboard 110 is an example of the board used in the meeting. However, the board is not limited to the whiteboard 110. For example, the board used in the meeting may be an electronic blackboard (an interactive whiteboard) that may electrically detect the presence/absence of description or described contents. In this case, the monitoring of the description state or the acquisition of the described object as described above may be performed by an information processing performed using the electronic blackboard, rather than the board image capturing camera 201.

For example, in an electronic blackboard capable of detecting a contact by a pen, the above-described monitoring of the description state may be implemented in the manner than when the pen is in contact with the board in the state of non-description including the initial state, the description state is determined to be description, and when the pen is not in contact with the board for a specific time period during the description, the description state is determined to be non-description. In addition, an image of an object described on the board may be acquired by the electronic blackboard, and stored as the above-described described object.

In addition, the board used in the meeting may be, for example, a virtual board shared in screens of information terminals possessed by respective participants of the meeting.

In addition, descriptions have been made on a case where the meeting state is displayed for each of the time periods of before, during, and after a description of an object. However, the meeting state may be displayed for each object.

In addition, descriptions have been made on a case where the process of extracting an object is performed based on the result of the monitoring of whether a description is being performed or the time for the contact with the electronic blackboard. However, the extraction of an object is not limited to the process. For example, an input frame (section) such as the description area 111 may be provided on the board, and contents described within the input frame may be extracted as one object.

In addition, descriptions have been made on the configuration where the respective pieces of information of a time period of after a description of a specific object and the respective pieces of information of a time period of before a description of an object described after the specific object are separately stored. However, the present disclosure is not limited to the configuration. For example, since the two time periods indicate the same time period, any one of the two time periods may be stored.

For example, in the example illustrated in FIG. 29, the respective pieces of information of the time period of after the description of the object #1 in the attribute information 1730 are the same as those of the time period of before the description of the object #2 in the attribute information 2530. Thus, for example, the respective pieces of information of the time period of before the description may be omitted from the attribute information 2530. In this case, when the user designates the time period of before the description of the object #2, the respective pieces of the time period of after the description in the attribute information 1730 may be referred-to as the respective pieces of information of the time period of before the description of the object #2.

As described above, according to the facilitation support program, the facilitation support apparatus, and the facilitation support method, a speech on an object described on a board is easily identified so that the facilitation may be supported.

For example, as a method of recording details of meeting contents, there is a method of recording character information such as minutes or the like, a recording method with a voice or video recorder, and a method of storing voice data recorded with a voice or video recorder in association with material data or information elements (characters or drawings). However, for example, in a meeting progressed by collating multiple opinions such as making an idea, checking a status, or analyzing a method, it is difficult to recall images of the meeting at that time from the summarized minutes, when the details of the meeting are identified at a later time. Further, in the recorded data of the meeting, there is a problem in that it takes time to find a desired recording position, it takes time to listen to the entire recorded data, or the desired recording position is missing by listening to some parts of the recorded data.

To the contrary, according to the above-described embodiment, for example, discussed contents which are sequentially updated on the whiteboard (visualization of opinions) and voice data obtained by a recording are stored, and speakers, a meeting state and others are also stored together with the voice data. Then, when the information is reproduced, the flow of the meeting may be visualized by characters or drawings described on the whiteboard. Further, voice may be quickly found in the unit of a speaker or object, so that the details of the meeting may be identified in a short time.

For example, when a review of design of a developer is conducted, drawings described on the whiteboard in the place where concerns, recommendations and others are discussed on the developed product may be stored in association with voice, a speaker, a meeting state and others at that time. Then, the stored information is visualized so that when the design is corrected at a later date, voice of the position where the concerns or recommendations are discussed in the design review may be quickly and accurately identified.

In addition, the facilitation support method described in the present embodiment may be implemented in the manner that prepared programs are executed by a computer such as a PC, a workstation, or the like. The programs are recorded in a computer readable recording medium such as a hard disk, a flexible disk, a CD-ROM, an MO, a DVD or the like, and are executed by being read from the recording medium. The CD-ROM stands for compact disc-read only memory. The MO refers to a magneto optical disk. The DVD stands for digital versatile disc. In addition, the programs may be distributed through a network such as the Internet or the like.

All examples and conditional language recited herein are intended for pedagogical purposes to aid the reader in understanding the invention and the concepts contributed by the inventor to furthering the art, and are to be construed as being without limitation to such specifically recited examples and conditions, nor does the organization of such examples in the specification relate to an illustrating of the superiority and inferiority of the invention. Although the embodiments of the present invention have been described in detail, it should be understood that the various changes, substitutions, and alterations could be made hereto without departing from the spirit and scope of the invention.

What is claimed is:

1. A non-transitory computer-readable recording medium having stored therein a program that causes a computer to execute a process, the process comprising:
storing, in a memory, speaker information and voice information in association with each of objects described on a board in a discussion, the speaker information being information that identifies a speaker in each of time periods of before, during, and after a description of each of the objects, the voice information being information that identifies a voice from recorded voices of the discussion in each of the time periods related to each of the objects;
receiving a designation of an object among the objects described on the board;
identifying a speaker in each of the time periods related to the designated object based on the speaker information stored in the memory;
outputting information that indicates the identified speaker in each of the time periods related to the designated object in association with each of the time periods related to the designated object;
receiving a designation of a time period from the time periods related to the designated object;
identifying a voice in the designated time period related to the designated object based on the voice information stored in the memory; and
outputting data of the identified voice.

2. The non-transitory computer-readable recording medium according to claim 1, the process further comprising:
monitoring whether each of participants of the discussion is performing a description on the board;
extracting an object described on the board based on a result of the monitoring and on an image that represents contents described on the board in the discussion;
detecting a speaker in each of the time periods related to the extracted object based on the recorded voices; and
storing the speaker information related to the extracted object in the memory.

3. The non-transitory computer-readable recording medium according to claim 2, the process further comprising:
determining a distance between a head and a hand of each of the participants in the discussion based on captured image data that is obtained by an image capturing in the discussion; and
determining whether each of the participants is performing a description on the board based on the distance.

4. The non-transitory computer-readable recording medium according to claim 3, the process further comprising:
determining that a participant is performing a description on the board when a distance determined for the participant is equal to or more than a predetermined threshold; and
determining that the participant is not performing a description on the board when the distance determined for the participant is less than the predetermined threshold.

5. The non-transitory computer-readable recording medium according to claim 2, the process further comprising:
discriminating each of the time periods related to the extracted object by timings of starting and finishing of the description of the extracted object based on the result of the monitoring.

6. The non-transitory computer-readable recording medium according to claim 1, the process further comprising:
storing, in association with each of the objects described on the board in the discussion, state information that identifies a state of the discussion in each of the time periods related to each of the objects;
identifying a state of the discussion in each of the time periods related to the designated object based on the state information stored in the memory; and
outputting information that indicates the identified state of the discussion in each of the time periods related to the designated object in association with each of the time periods related to the designated object.

7. The non-transitory computer-readable recording medium according to claim 1, the process further comprising:
receiving a designation of a state of the discussion;
identifying, among the objects described on the board in the discussion, at least one object such that at least one of the time periods related to each of the at least one object includes a time period in which the discussion is in the designated state;
outputting information that indicates the at least one object;
receiving a designation of an object among the at least one object; and
identifying a speaker in each of the time periods related to the object designated among the at least one object.

8. The non-transitory computer-readable recording medium according to claim 6, wherein
the state of the discussion in a specific time period among the time periods related to each of the objects described on the board is a state determined based on at least one of a state related to an emotion of a speaker in the specific time period, a number of speakers in the specific time period, a number of speeches per time in the specific time period, a state related to an emotion of a participant in the specific time period, or a time length of the specific time period.

9. The non-transitory computer-readable recording medium according to claim 1, the process further comprising:
receiving a designation of a participant among participants of the discussion;
identifying, among the objects described on the board in the discussion, at least one object such that at least one of the time periods related to each of the at least one object includes a time period in which the designated participant speaks;
outputting information that indicates the at least one object; and
identifying the speaker in each of the time periods related to the designated object.

10. The non-transitory computer-readable recording medium according to claim 1, the process further comprising:
Outputting, with respect to the designated object, information that indicates at least one of an object described on the board immediately before the designated object or an object described on the board immediately after the designated object.

11. The non-transitory computer-readable recording medium according to claim 1, wherein
each of the objects is information including at least one of a described character or a drawn picture.

12. The non-transitory computer-readable recording medium according to claim 1, wherein
when there is a leading object described before the designated object in the discussion, the time period of before the description of the designated object is a time period from finishing of the description of the leading object to starting of the description of the designated object, and
when there is a trailing object described after the designated object in the discussion, the time period of after the description of the designated object is a time period from finishing of the description of the designated object to starting of the description of the trailing object described.

13. An information processing apparatus, comprising:
a memory; and
a processor coupled to the memory and the processor configured to:
store, in the memory, speaker information and voice information in association with each of objects described on a board in a discussion, the speaker information being information that identifies a speaker in each of time periods of before, during, and after a description of each of the objects, the voice information being information that identifies a voice from recorded voices of the discussion in each of the time periods related to each of the objects;
receive a designation of an object among the objects described on the board;
identify a speaker in each of the time periods related to the designated object based on the speaker information stored in the memory;
output information that indicates the identified speaker in each of the time periods related to the designated object in association with each of the time periods related to the designated object;
receive a designation of a time period from the time periods related to the designated object;
identify a voice in the designated time period related to the designated object based on the voice information stored in the memory; and
output data of the identified voice.

14. A facilitation support method, comprising:
storing in a memory, by a computer, speaker information and voice information in association with each of objects described on a board in a discussion, the speaker information being information that identifies a speaker in each of time periods of before, during, and after a description of each of the objects, the voice information being information that identifies a voice from recorded voices of the discussion in each of the time periods related to each of the objects;
receiving a designation of an object among the objects described on the board;
identifying a speaker in each of the time periods related to the designated object based on the speaker information stored in the memory;
outputting information that indicates the identified speaker in each of the time periods related to the designated object in association with each of the time periods related to the designated object;
receiving a designation of a time period from the time periods related to the designated object;
identifying a voice in the designated time period related to the designated object based on the voice information stored in the memory; and
outputting data of the identified voice.
